(19) United States
(12) Patent Application Publication
(10) Pub. No.: US 2025/0371289 A1
(43) Pub. Date: Dec. 4, 2025

(54) DATA EXTRACTION AND ENHANCEMENT USING ARTIFICIAL INTELLIGENCE

(71) Applicant: Roku, Inc., San Jose, CA (US)

(72) Inventor: Ritwick Babbar, Fremont, CA (US)

(21) Appl. No.: 18/680,112

(22) Filed: May 31, 2024

(51) Int. Cl. G06F 40/47; H04N 21/84

(52) U.S. Cl. CPC G06F 40/47; H04N 21/84

(57) ABSTRACT

System, apparatus, article of manufacture, method and/or computer program product embodiments (and/or combinations and sub-combinations thereof) are provided for using AI/ML models to generate context-aware metadata for a media content item based on audio-related text data associated with the media content item. An example method can include obtaining text data associated with a content item, the text data including a transcription/translation of audio associated with the content item; determining a modified version of the text data based on a deviation in a playback timeline of the content item, topics associated with the text data, a chronological timeline associated with the content item, and/or a sequence of events associated with the content item and/or content of the content item; generating a representation of the modified version of the text data; and generating metadata associated with the content item based on the representation of the modified version of the text data.

### BACKGROUND

### Field

This disclosure is generally directed to generating context-aware embeddings from closed caption and/or subtitle data associated with a content item and using the context-aware embeddings and artificial intelligence models to generate context-aware metadata for the content item.

### Summary

Provided herein are system, apparatus, article of manufacture, method and/or computer program product embodiments (and/or combinations and/or sub-combinations thereof) for using artificial intelligence (AI) and/or machine learning (ML) models to generate context-aware metadata for a media content item based on audio-related text data (e.g., embeddings) associated with the media content item. The system, apparatus, article of manufacture, method and/or computer program product embodiments (and/or combinations and/or sub-combinations thereof) provided herein can use the context-aware metadata for various use cases or applications. For example, in some cases, the system, apparatus, article of manufacture, method and/or computer program product embodiments (and/or combinations and/or sub-combinations thereof) provided herein can use the context-aware metadata to enhance content experiences associated with the media content item, such as live content experiences, streaming content experiences, and video gaming experiences, among others.

In some aspects, a method is provided for using AI/ML models and audio-related text data to generate context-aware metadata for the media content item. In some cases, the method can include using the context-aware metadata to enhance content experiences associated with the media content item, such as live content experiences, streaming content experiences, and video gaming experiences, among others. The method can be implemented by a computing device(s), such as a desktop computer, a set-top box, an Internet-of-Things (IoT) device, a peripheral device, a mobile device (e.g., a laptop computer, a tablet computer, a smartphone, etc.), a server computer, a wearable computing device (e.g., a smart watch, smart glasses, a head-mounted display (HMD), etc.), an edge device, a smart device (e.g., a smart television, a smart appliance, etc.), among others.

The method can include obtaining text data associated with a content item. The text data can include, for example, a transcription and/or a translation of audio associated with the content item. The method can further include determining a modified version of the text data based on a deviation in a playback timeline of the content item, topics associated with the text data, a chronological timeline associated with the content item, and/or a sequence of events associated with the content item and/or a content of the content item; generating a representation of the modified version of the text data; and generating metadata associated with the content item based on the representation of the modified version of the text data.

In some aspects, a system is provided for using AI/ML models and audio-related text data (e.g., embeddings, etc.) to generate context-aware metadata for the media content item. In some cases, the system can use the context-aware metadata to enhance content experiences associated with the media content item, such as live content experiences, streaming content experiences, and video gaming experiences, among others. The system can include a computing device(s), such as a server computer, a desktop computer, a set-top box, an loT device, a peripheral device, a mobile device (e.g., a laptop computer, a tablet computer, a smartphone, etc.), a wearable computing device (e.g., a smart watch, smart glasses, an HMD, etc.), an edge device, a smart device (e.g., a smart television, a smart appliance, etc.), among others.

The system can include memory used to store data, such as computing instructions, and one or more processors coupled to the memory and configured to obtain text data associated with a content item. The text data can include, for example, a transcription and/or a translation of audio associated with the content item. The one or more processors can be further configured to determine a modified version of the text data based on a deviation in a playback timeline of the content item, topics associated with the text data, a chronological timeline associated with the content item, and/or a sequence of events associated with the content item and/or a content of the content item; generate a representation of the modified version of the text data; and generate metadata associated with the content item based on the representation of the modified version of the text data.

In some aspects, a non-transitory computer-readable medium is provided for using AI/ML models and audio-related text data (e.g., embeddings, etc.) to generate context-aware metadata for the media content item. In some cases, the non-transitory computer-readable medium can use the context-aware metadata to enhance content experiences associated with the media content item, such as live content experiences, streaming content experiences, and video gaming experiences, among others.

The non-transitory computer-readable medium can have instructions stored thereon that, when executed by one or more processors, cause the one or more processors to obtain text data associated with a content item. The text data can include, for example, a transcription and/or a translation of audio associated with the content item. The instructions can further cause the one or more processors to determine a modified version of the text data based on a deviation in a playback timeline of the content item, topics associated with the text data, a chronological timeline associated with the content item, and/or a sequence of events associated with the content item and/or a content of the content item; generate a representation of the modified version of the text data; and generate metadata associated with the content item based on the representation of the modified version of the text data.

### BRIEF DESCRIPTION OF THE FIGURES

The accompanying drawings are incorporated herein and form a part of the specification.

FIG. 1 illustrates a block diagram of a multimedia environment, according to some examples of the present disclosure.

FIG. 2 illustrates a block diagram of a streaming media device, according to some examples of the present disclosure.

FIG. 3 is a diagram illustrating an example system for preprocessing audio-related text data, according to some examples of the present disclosure.

FIG. 4 is a diagram illustrating an example sequence of audio-related text data associated with a content item, according to some examples of the present disclosure.

FIG. 5 is a diagram illustrating an example organization of a preprocessing output text generated by a data preprocessing system from audio-related text data associated with the content item, according to some examples of the present disclosure.

FIG. 6 is a diagram illustrating an example system process for using a preprocessing text output from a data preprocessing system to generate metadata associated with a content item, according to some examples of the present disclosure.

FIG. 7 is a diagram illustrating an example correlation between portions of audio-related text data associated with a content item and metadata generated for the content item based on the audio-related text data, according to some examples of the present disclosure.

FIG. 8 is a flowchart illustrating an example method for preprocessing text data associated with a content item to generate a preprocessed text output used to generate metadata for the content item, according to some examples of the present disclosure.

FIG. 9 is a flowchart illustrating an example method for using models to generate context-aware metadata for a content item, according to some examples of the present disclosure.

FIG. 10 is a flowchart illustrating an example method for using preprocessing text data associated with a content item to generate context-aware metadata for a content item based on audio-related text data associated with the content item.

FIG. 11 is a diagram illustrating an example architecture of an example neural network, according to some examples of the present disclosure.

FIG. 12 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can generally access and consume media content using client devices such as, for example and without limitation, smart phones, set-top boxes, desktop computers, laptop computers, tablet computers, televisions (TVs), IPTV receivers, media devices, monitors, projectors, smart wearable devices (e.g., smart watches, smart glasses, head-mounted displays (HMDs), etc.), appliances, and Internet-of-Things (IoT) devices, among others. The media content can include various types of content such as, for example and without limitation, videos (e.g., live video content broadcast by a content server(s) to the client devices, pre-recorded video content available to the client devices on-demand, streaming video content, television shows, movies, etc.), audio, and images, among others. In some instances, the media content can be adjusted to include additional content such as targeted media content, metadata, and/or any other content. In some cases, the additional content can include, for example, one or more frames (e.g., one or more video frames and/or still images), audio content, text such as closed captions and/or subtitles, customized content, and/or any other content.

Metadata of a media content item can provide various types of information about the media content item such as, for example, cast information, genre information, information about a content category, ratings, file information, tag data, content information, associated keywords, title information, and/or descriptive information, among other information. The metadata can provide useful information about the media content item and can be used for various purposes. For example and without limitation, the metadata can be used to obtain certain details about the media content item, sort or group the media content item with other media content items, create a thumbnail or preview associated with the media content item, obtain statistics about the media content item, provide (or obtain) a description of the media content item, recommend content and/or portions of content to users, or select other content to include in the media content item such as targeted media content or advertisements.

Unfortunately, while metadata can be valuable and may be used for various purposes, media content items often have limited, incorrect, or inaccurate metadata, or may even lack any metadata. Nevertheless, the metadata for a media content item can be generated using data from and/or about the media content item, such as a content and/or media asset(s) (e.g., video, audio, text, and/or image assets) of the media content item. However, in many cases, generating accurate and sufficient metadata for a particular purpose(s) can be difficult, costly, and time-consuming. For example, to generate metadata for a content item, a content of the media content item, such as an image content (e.g., video frames, still images, etc.) and/or audio content of the media content item, can be analyzed to extract details about the media content item used to generate (and/or include in) the metadata for the media content item. The analysis of the content (e.g., the image content and/or audio content) can be difficult, time-consuming, costly, resource intensive, and May involve expensive and/or complex systems such as artificial intelligence models, computer vision algorithms, etc.

In some examples, text data of a media content item, such as closed captions or subtitles, can be used to gain insights about the media content item, which can be used to generate metadata for the content item. However, in many cases, the media content item may lack or have limited text data such as subtitles or closed captions. Moreover, the text data may provide limited information or may be arranged in a way that provides limited insights into the media content item or is difficult to process and understand. For instance, if the text data includes closed caption data corresponding to a scene provided within or as part of a deviation in a timeline of the media content item, such as a flashback or a recap, the deviation may increase the difficulty of understanding the information from the closed caption data and/or extracting meaningful information from the closed caption data as the information conveyed in the closed caption data may seem out of place and may lack context information, and the data from portions of the timeline before and/or after the deviation in the timeline may have limited relevance to the information in the closed caption or may not even provide sufficient (or any) related details that would otherwise help understand the information in the closed caption data.

Provided herein are system, apparatus, device, method (also referred to as a process) and/or computer program product embodiments (and/or combinations and/or sub-combinations thereof) for using an artificial intelligence (AI) and/or machine learning (ML) model to generate metadata, such as context-aware metadata, for a media content item. In some examples, the AI/ML models may generate the metadata for the media content item based at least partly on text data associated with the media content item, such as closed captions, subtitles, and/or embeddings encoding/representing the closed captions and/or subtitles. In some examples, the text data associated with the media content item can be preprocessed by a system (e.g., an algorithm, an AI/ML model, etc.) to add other relevant information to the preprocessed text data; group information in the preprocessed text data based on one or more grouping factors, such as topics, events, relevance/relationships, characters, scenes, timelines, dates/times, and/or any other factors; and/or arrange the information in the preprocessed text data in a more desirable and/or meaningful way.

The preprocessed text data can make it easier for the AI/ML model to analyze and understand the information in the preprocessed text data, increase the quality of the metadata generated based on the preprocessed text data, and allow the AI/ML model to extract and/or obtain more accurate, complete, meaningful, and/or relevant information (e.g., metadata) from the preprocessed text data. For example, the other relevant information added to the preprocessed text data, the grouping of information in the preprocessed text data, and the arrangement of the information in the preprocessed text data can make it easier for the AI/ML model to analyze and understand the information in the preprocessed text data, increase the quality of the metadata generated based on the preprocessed text data, and allow the AI/ML model to extract and/or obtain more accurate, complete, meaningful, and/or relevant information (e.g., metadata) from the preprocessed text data.

In some cases, the other relevant information added by the system to the preprocessed text data can include information obtained (e.g., extracted, inferred, determined, generated, etc.) from one or more portions of the text data associated with the media content item and/or other data sources/assets such as, for example and without limitation, audio, video, and/or image assets associated with the media content item. The metadata generated by the AI/ML model can be used in various use cases, applications, and/or implementations. For example, the metadata can be used to select, sell, and/or provide tailored media content items with/for the media content item, such as tailored advertisements. In some implementations, the metadata can be used to enhance, tailor, and/or improve content experiences associated with the media content item, such as live content experiences, streaming content experiences, and video gaming experiences, among others. In other implementations, the metadata can additionally or alternatively be used to generate media content trailers or previews, content recaps (e.g., season recaps, event recaps, etc.), short-form video content (also referred to as “shorts”), a content storyline or mashup, a set of scenes stitched together into a particular sequence of scenes, etc.

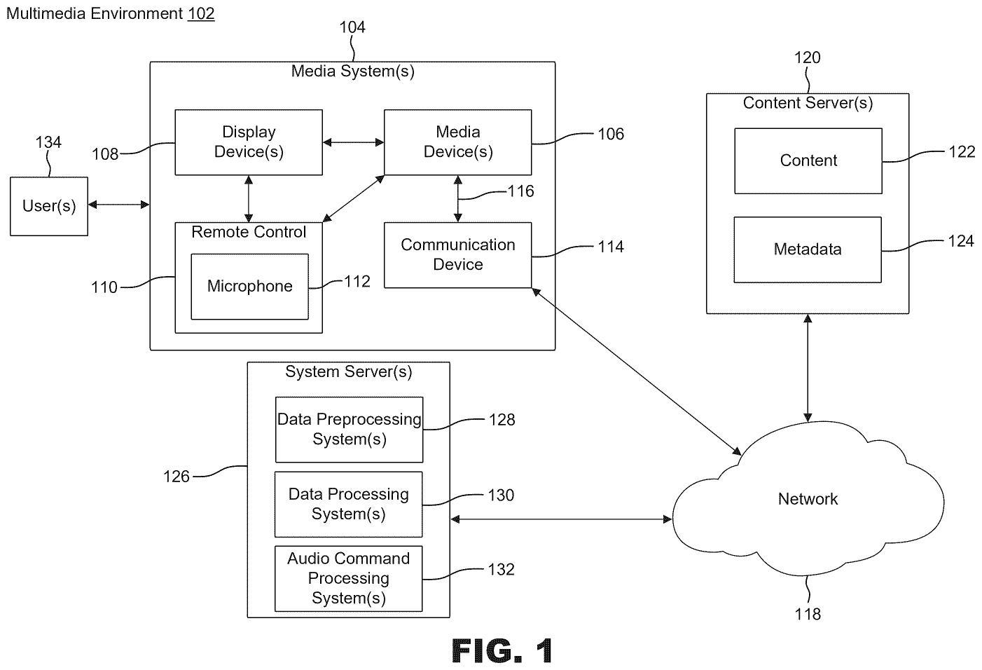

Various embodiments and aspects of this disclosure may be implemented using and/or may be part of multimedia environment 102 shown in FIG. 1. It is noted, however, that the multimedia environment 102 is provided solely for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Example Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 can include and/or represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. Any user 134 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Each of the one or more media devices 106 may be or include a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, each of the one or more media devices 106 can be a part of, integrated with, operatively coupled to, and/or connected to a respective display device 108.

Each of the one or more media devices 106 may be configured to communicate with network 118 via a respective communication device 114. The communication device 114 may include, for example, a cable modem or satellite TV transceiver. The one or more media devices 106 may communicate with the communication device 114 over a link 116, wherein the link 116 may include wireless (such as WiFi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the one or more media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the one or more media devices 106 and/or display device 108 using cellular, Bluetooth, infrared, etc., or any combination thereof. The remote control 110 may include a microphone 112, which is further described below.

The multimedia environment 102 may include one or more content servers 120 (also called content providers, channels or sources). Although only one content server is shown in FIG. 1, in practice, the multimedia environment 102 may include any number of content servers. Each of the one or more content servers 120 may be configured to communicate with network 118.

Each of the one or more content servers 120 may store content 122 and metadata 124. Content 122 may include any combination of music, videos, movies, TV programs, multimedia, images, still pictures, text, graphics, gaming applications, advertisements, programming content, public service content, government content, local community content, targeted media content, software, and/or any other content or data objects in electronic form.

In some examples, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

In some examples, the one or more content servers 120 and/or the one or more media devices 106 can process media content segments to extract features and information, such as contextual information, from the media content segments and classify the media content segments based on the extracted features and information. In some examples, the one or more content servers 120 or the one or more media devices 106 can determine and/or extract information (e.g., contextual information, content information and/or attributes, segment characteristics, etc.) about one or more segments of media content, and use the information to categorize the one or more segments of the media content. The one or more content servers 120 or the one or more media devices 106 can use the categorization to match targeted media content with the one or more media content segments, which can be presented at the display device 108 with or within the one or more media content segments, or with or within a break before or after the one or more media content segments. For example, the one or more content servers 120 or the one or more media devices 106 can add the targeted media content to the one or more media content segments at a certain location(s) within the one or more media content segments for presentation with and/or as part of the one or more media content segments.

To illustrate, in some aspects, the one or more content servers 120 or the one or more media devices 106 can segment media content based on identified boundaries or breaks between portions (e.g., segments) of the media content. The one or more content servers 120 or the one or more media devices 106 can adjust a segment of media content to include and/or present targeted media content matched with the segment, in addition to any media content of the segment. The targeted media content to include in or present with a segment can include content matched with the segment based on a determination of a relationship, similarity, correspondence, and/or relevance to the content in that segment. In some examples, to match targeted media content with a segment of media content, the one or more content servers 120 or the one or more media devices 106 can use an algorithm, such as a machine learning algorithm, to generate one or more embeddings encoding information about the content of the segment of the media content. The one or more content servers 120 or the one or more media devices 106 can generate the one or more embeddings based on one or more signals in one or more frames of the segment of the media content, such as a visual signal (e.g., image data), an audio signal (e.g., audio data), a closed-caption signal (e.g., text data), and/or any other signal.

The one or more content servers 120 or the one or more media devices 106 can use the one or more embeddings to determine a category for the segment of the media content that describes, represents, summarizes, classifies, and/or identifies the segment of the media content, the content of the segment of the media content, a context(s) of the content of the segment of the media content, and/or one or more characteristics of the segment of the media content and/or the content of the segment of the media content. In some cases, targeted media content available to the one or more content servers 120 or the one or more media devices 106 can include one or more respective categories determined for and/or assigned to the targeted media content. In other cases, the targeted media content available to the one or more content servers 120 or the one or more media devices 106 may not have an associated category determined for and/or assigned to the target media content, in which case the one or more content servers 120 or the one or more media devices 106 can similarly generate embeddings for the targeted media content and use such embeddings to determine and/or assign one or more respective categories for the targeted media content. The content server 120 or the one or more media devices 106 can use the determined category for the segment of the media content and the respective categories of different targeted media content to match the segment of the media content with a particular targeted media content item(s).

The one or more content servers 120 or the one or more media devices 106 can include the particular targeted media content item(s) with the segment of the media content for presentation with or within the segment of the media content. As a result, the one or more content servers 120 or the one or more media devices 106 can, among other things, better match media content segments with targeted media content, which can be presented with or within the matched media content segments, and thereby increase the relevance, similarity, relationship, and/or correspondence of the targeted media content and the media content segments. This way, the one or more content servers 120 or the one or more media devices 106 can increase an interest of the user 134 in the targeted media content, a recall of the targeted media content by the user 134, an engagement of the user 134 with the targeted media content, and/or other performance metrics.

The multimedia environment 102 may include one or more system servers 126. The one or more system servers 126 may operate to support the one or more media devices 106 from the cloud. It is noted that the structural and functional aspects of the one or more system servers 126 may wholly or partially exist in the same or different ones of the system servers 126.

In some examples, the one or more system servers 126 may include a data preprocessing system(s) 128 and a data processing system(s) 130. In some cases, the data preprocessing system(s) 128 and the data processing system(s) 130 can be part of or implemented by a same system, such as a same server(s), virtual machine(s) (VM(s)), software container(s), software model(s), and/or any other computing device(s). In other cases, the data preprocessing system(s) 128 and the data processing system(s) 130 can be part of or implemented by different systems, such as different servers, VMs, software containers, software models, and/or any other computing devices.

In some cases, the data preprocessing system(s) 128 can operate to process audio-related text data (e.g., closed caption data, subtitles, etc.) of a content item (e.g., a podcast, a television show, a movie, a video, a video game, a livestream, a video segment, etc.) to extract features and information, such as contextual information, from the content item and generate context-aware audio-related text data (e.g., context-aware embeddings representing and/or encoding information from the audio related text data of the content item). In some examples, the data preprocessing system(s) 128 can use the audio-related text data of the content item to enhance/augment the audio-related text data (e.g., closed caption data, subtitles, etc.) with context information, which the data preprocessing system(s) 128 can extract from the content item (e.g., from audio, video, and/or text corresponding to the content item) and group or organize the enhanced/augmented audio-related text data based on topics associated with the content item, events associated with the content item, a desired sequence (e.g., a chronological, etc.), and/or any other grouping, organization, and/or sequence.

The data processing system(s) 130 can use the output from the data preprocessing system(s) 128 (e.g., the enhanced/augmented audio-related text data) to generate metadata for the content item. The metadata can be based on and/or can encode/represent context information associated with the content item. For example, the metadata can describe one or more aspects and/or elements of the content item, which can include any associated and/or relevant context information. In some aspects, the data processing system(s) 130 can use the generated metadata to enhance content experiences associated with the content item, such as live content experiences, streaming content experiences, and video gaming experiences, among others. In some implementations, the data processing system(s) 130 can additionally or alternatively use the metadata to generate media content trailers or previews, content recaps (e.g., season recaps, event recaps, etc.), short-form video content (e.g., “shorts”), a content storyline or mashup, a set of scenes stitched together into a particular sequence of scenes, and/or any other content or content experience.

The one or more system servers 126 may also include an audio command processing system 132. As noted above, the remote control 110 may include a microphone 112. The microphone 112 may receive audio data from users 134 (as well as other sources, such as the display device 108). In some examples, the one or more media devices 106 may be audio responsive, and the audio data may represent verbal commands from the user 134 to control the one or more media devices 106 as well as other components in the media system 104, such as the display device 108.

In some examples, the audio data received by the microphone 112 in the remote control 110 can be transferred to the one or more media devices 106, which can then be forwarded to the audio command processing system 132 in the one or more system servers 126. The audio command processing system 132 may operate to process and analyze the received audio data to recognize the verbal command of the user 134. The audio command processing system 132 may then forward the verbal command back to the one or more media devices 106 for processing.

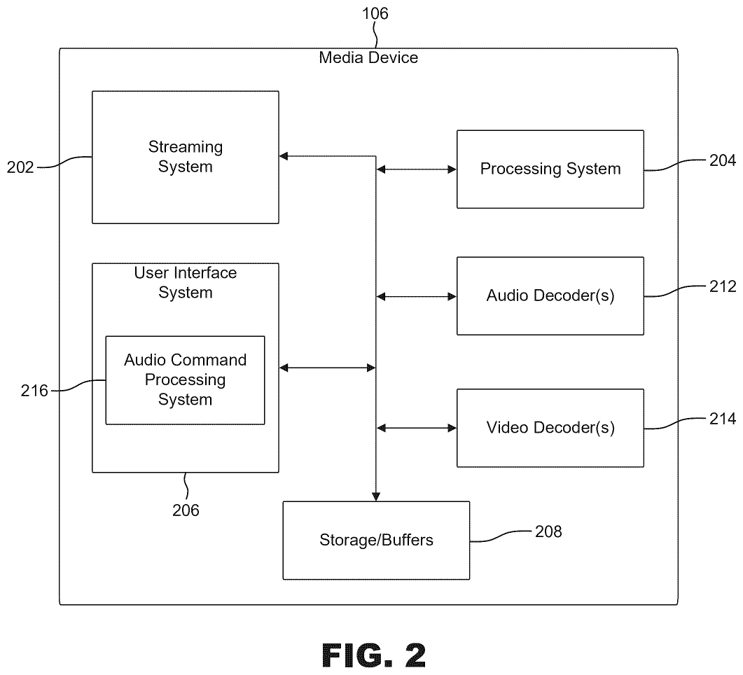

In some examples, the audio data may be alternatively or additionally processed and analyzed by an audio command processing system 216 in the one or more media devices 106 (see FIG. 2). The one or more media devices 106 and the one or more system servers 126 may then cooperate to pick one of the verbal commands to process (either the verbal command recognized by the audio command processing system 132 in the one or more system servers 126, or the verbal command recognized by the respective audio command processing system 216 in the one or more media devices 106).

FIG. 2 illustrates a block diagram of an example media device, according to some embodiments. In FIG. 2, the media device 106 represents a media device from the one or more media devices 106. Moreover, the media device 106 in FIG. 2 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. The media device 106 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 134 may interact with the media device 106 via, for example, the remote control 110. For example, the user 134 may use the remote control 110 to interact with the user interface module 206 of the media device 106 to select content, such as a movie, TV show, music, book, application, game, etc. The streaming system 202 of the media device 106 may request the selected content from the one or more content servers 120 over the network 118. The one or more content servers 120 may transmit the requested content to the streaming system 202. The media device 106 may transmit the received content to the display device 108 for playback to the user 134.

In streaming examples, the streaming system 202 may transmit the content to the display device 108 in real time or near real time as it receives such content from the one or more content servers 120. In non-streaming examples, the media device 106 may store the content received from one or more content servers 120 in storage/buffers 208 for later playback on display device 108.

Extracting Context from Content and Generating Associated Context-Aware Metadata

Referring to FIG. 1, the data preprocessing system(s) 128 in the one or more system servers 126 can operate to process audio-related text data (e.g., closed caption data, subtitles, etc.) of a content item (e.g., a podcast, a television show, a movie, a video, a video game, a livestream, a video segment, etc.) to extract features and information, such as contextual information, from the content item and generate context-aware audio-related text data (e.g., context-aware embeddings representing and/or encoding information from the audio related text data of the content item). In some examples, the data preprocessing system(s) 128 can use the audio-related text data of the content item to enhance/augment the audio-related text data (e.g., closed caption data, subtitles, etc.) with context information, which the data preprocessing system(s) 128 can extract from the content item (e.g., from audio, video, and/or text corresponding to the content item) and group or organize the enhanced/augmented audio-related text data based on topics associated with the content item, events associated with the content item, a desired sequence (e.g., a chronological, etc.), and/or any other grouping, organization, and/or sequence.

The data processing system(s) 130 in the one or more system servers 126 can use the output from the data preprocessing system(s) 128 (e.g., the enhanced/augmented audio-related text data) to generate metadata for the content item. The metadata can be based on and/or can encode/represent context information associated with the content item. For example, the metadata can describe one or more aspects and/or elements of the content item, which can include any associated and/or relevant context information. In some aspects, the data processing system(s) 130 can use the generated metadata to enhance content experiences associated with the content item, such as live content experiences, streaming content experiences, and video gaming experiences, among others. In some implementations, the data processing system(s) 130 can additionally or alternatively use the metadata to generate media content trailers or previews, content recaps (e.g., season recaps, event recaps, etc.), short-form video content (e.g., “shorts”), a content storyline or mashup, a set of scenes stitched together into a particular sequence of scenes, and/or any other content or content experience.

### Preprocessing Text Data of a Content Item and Generating Associated Metadata

The disclosure now continues with a further discussion of generating context-aware audio-related text data (e.g., audio-related embeddings, text representations, structured text, etc.) from an audio and/or text asset(s) of a content item and using an AI/ML model(s) and the context-aware audio-related text data to create context-aware metadata for the content item. In some implementations, the context-aware metadata can provide informative, descriptive, representative, detailed, contextual, diverse, encompassing, complex, practical, accurate, and/or relevant information about a content item and can be used in various scenarios, use cases, applications, embodiments, implementations, and/or contexts, including scenarios where the content item otherwise lacks metadata (or has insufficient metadata) or, if there is any metadata available for the content item, such metadata is less informative, descriptive, representative, detailed, contextual, accurate, useful, diverse, encompassing, effective, complete, complex, practical, and/or relevant than the context-aware metadata described herein. The context-aware metadata described herein can be used for various purposes and/or in various scenarios, use cases, applications, embodiments, implementations, and/or contexts. For example, in some cases, the context-aware metadata described herein can be used for advertising (e.g., digital content advertising such as programmatic video advertising and/or any other advertising type or implementation), can create better and/or additional advertising options/opportunities, and/or can support, enable, and/or create more accurate, effective, valuable, practical, diverse, customizable, useful, wide-ranging, tailored, intelligent, immersive, stable, innovative, and/or complex advertising and advertising campaigns.

In some aspects, the context-aware metadata described herein can be used to create, provide, and/or support more effective, diverse, tailored, wide-ranging, valuable, immersive, innovative, desirable, accurate, flexible, interesting, dynamic, and/or robust content experiences associated with the content item than content experiences created and/or provided without the context-aware metadata described herein and/or that do not reflect, encompass, embody, use, account for, rely on, and/or depend on such context-aware metadata. For example, such context-aware metadata can support, enable, enhance/enrich, customize, and/or implement various content experiences associated with the content item such as live content experiences (e.g., live video experiences, live gaming experiences, live chatting and/or conferencing experiences, etc.), streamed content experiences, digital entertainment experiences, immersive media content experiences, extended reality (e.g., virtual reality, augmented reality, mixed reality, virtual reality with video passthrough, etc.) experiences, content animation experiences, video gaming experiences, and/or any other media content experiences. In some implementations, the context-aware metadata described herein can additionally or alternatively be used to generate digital/media content trailers or previews, content recaps (e.g., season recaps, event recaps, segment recaps, storyline recaps, etc.), short-form video content (also referred to as video “shorts”), content storylines or mashups, customized sequences of scenes (e.g., sets of scenes stitched together into particular sequences of scenes), digital video or image collages, etc.

The context-aware metadata described herein can be generated based at least partly on audio-related text data associated with a content item described by (and/or corresponding to) the context-aware metadata. As used herein, a content item (e.g., the content item associated with context-aware metadata) can include, represent, and/or reflect any digital content (e.g., media or multimedia content, etc.), asset, file, and/or data structure such as, for example and without limitation, a movie, a television show, a video and/or audio podcast, a broadcast (e.g., a radio broadcast, a video broadcast, etc.), a video blog (also referred to as a “vlog”), a livestream (e.g., video and/or audio livestream), a video conference, a webinar, a video (e.g., a short-form video or video “short”, a live video, a recorded or on-demand video, an animated video, a video recording, a video recap, a video clip, a sequence of images with or without other type of media content such as audio, etc.), a video game, music, recorded speech, a sequence of media content (e.g., a sequence of video, image, text, and/or audio content), etc.

The audio-related text data associated with a content item (e.g., the audio-related text data used to generate context-aware metadata as described herein) can include any text data associated with the content item and/or a component(s) of the content item, such as an audio and/or visual (e.g., video, image, graphic, etc.) component(s) of the content item. For example, the audio-related text data associated with a content item can include a text version, description, asset, summary, and/or representation of one or more content signals and/or elements of the content item such as an audio of the content item, one or more audio elements of the content item (e.g., speech/dialogue, music, sounds, noise, etc.), video of the content item, one or more visual elements of the content item (e.g., graphics, animations, images, etc.), a text asset(s) of the content item, etc. In some examples, the audio-related text data associated with a content item can include a transcription and/or translation of audio associated with the content item, such as closed captions and/or subtitles associated with the content item. In some cases, the audio-related text data associated with the content item can additionally or alternatively include a text description, representation, translation, summary, and/or explanation of (and/or derived from) one or more visual elements of the content item, such as a description, translation, and/or representation of one or more events, actions, activities, conditions, scenes, gestures, communications and/or dialogues, characters, and/or sign language expressions depicted in a video(s), image(s), animation(s), rendering(s), and/or visualization associated with the content item.

The audio-related text data associated with a content item can be preprocessed to generate an output that represents, includes, describes, summarizes, captures, reflects, outlines, organizes (e.g., orders, arranges, sorts, formats, shuffles, structures, etc.), and/or corresponds to information included in, reflected in, described in, extracted from, and/or associated with the audio-related text data as well as other relevant information associated with the content item (and/or the audio-related text data associated with the content item), such as context information and/or any other details about the content item (and/or the audio-related text data) and/or associated with the content item (and/or the audio-related text data). The preprocessing output can include the audio-related text data (and/or a portion(s) thereof) and/or information in/from the audio-related text data, as well as other information associated with the content item and/or one or more portions of the audio-related text data, such as context information and/or any other information or details. For example, the preprocessing output can cover, describe, and/or include any of the information in the audio-related text data associated with the content item, such as a transcription and/or translation of any speech, noises, and/or dialogue in the content item.

To illustrate, assume that the content item is a movie and the audio-related text data includes closed caption data corresponding to an audio of the movie. In this example, the preprocessing output can include the closed captions (and/or any portions or information thereof) as well as any additional information about and/or pertaining to the movie, the closed captions, and/or any aspects conveyed by the closed captions. In some cases, the preprocessing output can modify the closed captions to include relevant contextual information and/or any other details that are relevant to the information in the closed captions (e.g., a dialogue in the closed captions) and/or a portion of the movie corresponding to the closed captions, such as a context of a scene associated with the closed captions, a context of a dialogue in the closed captions, any details about the movie that are not conveyed (or clearly conveyed) by the closed captions (e.g., any additional details about a portion of the movie that includes the closed captions), any other details that provide more information about the scene associated with the closed captions (e.g., about the dialogue in the closed captions and/or a scene where and when the dialogue took place within the timeline of the movie), any other details that can help a system understand the dialogue and/or any aspect(s) of the scene associated with the dialogue, and/or any other relevant details that the system can extract from the preprocessing output and/or use to generate more complete, accurate, and/or specific metadata associated with the movie and/or a portion of the movie corresponding to the closed captions.

For example, assume that the movie in the example above includes a flashback where the movie goes back in time (e.g., from a scene in the present or the future) to a scene from the past (e.g., a flashback scene) that was previously/initially depicted in a previous video frame(s) of the movie, and assume that the closed captions from the audio-related text data of the movie includes a previous conversation between two characters that was part of the scene from the past (e.g., the flashback scene depicted in the previous video frame(s) of the movie). While the closed captions from the audio-related text data capture the previous conversation and may even capture other relevant information, the closed captions (and the previous conversation in the closed captions) may nevertheless lack some relevant information/details pertaining to the previous conversation, the two characters associated with the previous conversation, and/or the flashback scene (e.g., the scene from the past), such as context information (e.g., a context of the flashback scene and/or the previous conversation associated with the flashback scene) and/or any other information/details pertaining to the flashback scene (e.g., any other information/details pertaining to the previous conversation, the two characters involved in the previous conversation, one or more aspects of the flashback scene, and/or any other relevant aspects of the movie).

However, the audio-related text data can be preprocessed to generate a preprocessing output that includes and/or conveys the information from the closed captions, such as the previous conversation, and adds other relevant information/details about the previous conversation, the flashback scene, and/or the movie, which are otherwise lacking from the closed captions (and/or the previous conversation in the closed captions) associated with the flashback scene, and/or fills any gaps in information pertaining to the flashback scene (e.g., pertaining to the previous conversation, the two characters in the previous conversation, and/or any other aspect of the flashback scene or the movie). For example, the preprocessing output can include the audio-related text data with additional context information and any other relevant details about the movie, the flashback scene, the previous conversation, and/or the two characters involved in the previous conversation. The information in the preprocessing output, including the information from the audio-related text data and any other information added by the preprocessing of the audio-related text data, can provide more accurate, complete, broad, specific, relevant, interesting, and/or informative details/information about the movie than the audio-related text data before the preprocessing. In some cases, the preprocessing output can be further processed to extract more complete, relevant, accurate, specific, encompassing (e.g., broader, comprehensive, etc.), informative, and/or meaningful information about the movie than may otherwise be extracted from the audio-related text data before the preprocessing and/or to generate metadata about the movie. Moreover, the metadata about the movie generated from the preprocessing output can be more complete, accurate, relevant, broad, specific, interesting, meaningful, and/or informative than the metadata about the movie that could otherwise be generated from the audio-related text data before the preprocessing.

In some cases, preprocessing the audio-related text data can additionally or alternatively include organizing or serializing (e.g., arranging, ordering, structuring, formatting, etc.) the information from the audio-related text data and any other information in the preprocessing output based on one or more organizing or serializing schemes, in order to increase or enhance the meaning of the information in the preprocessing output, help or enable a system processing such output to better understand the information in the output, help or enable the system processing such output to extract more information about the movie from the preprocessing output, and/or help or enable the system to use such output to generate more complete, relevant, meaningful, informative, accurate, and/or detailed metadata about the movie than the metadata that the system may otherwise generate from the audio-related text data before the preprocessing. For example, the preprocessing output can be organized or serialized based on topics, events, sequences/series, and/or any other aspects of the preprocessing output.

In some cases, when preprocessing audio-related text data associated with a content item, the information included in the preprocessing output can be organized in a particular manner that facilitates and/or improves a system's ability (and/or accuracy) to extract information about the content item, which can be used to generate context-aware metadata as further described herein. For example, when preprocessing the audio-related text data associated with a content item, the information in the preprocessing output can include any information from the audio-related text data as well as other information as further described herein, and the information in the preprocessing output can be organized to correlate, group, and/or enhance related/relevant information.

The preprocessing output can thus provide information from the audio-related text data and any additional information, such as context information, that can help a system extract relevant information, understand the information in the preprocessing output, and/or generate metadata for the content item. The preprocessing output can be used with or without other data (e.g., audio data and/or image/video data associated with the content item) to generate such metadata associated with the content item. For example, the preprocessing output can be analyzed to extract information about the content item and generate context-aware metadata for the content item. Since the preprocessing output can include information from the audio-related text data as well as other information such as context information, and can be organized or serialized (e.g., ordered, arranged, structured, etc.) in a more meaningful manner than the audio-related text data, the preprocessing output can be used to generate more complete, relevant, descriptive, detailed, specific, accurate, and/or informative metadata for the content item than the audio-related text data before it is preprocessed. In some examples, the information in the preprocessing output can be used to generate metadata for the content item that includes, conveys, describes, represents, reflects, and/or takes into account context information associated with the content item and provides more accurate, informative, detailed, relevant, and/or complete details and information about the content item.

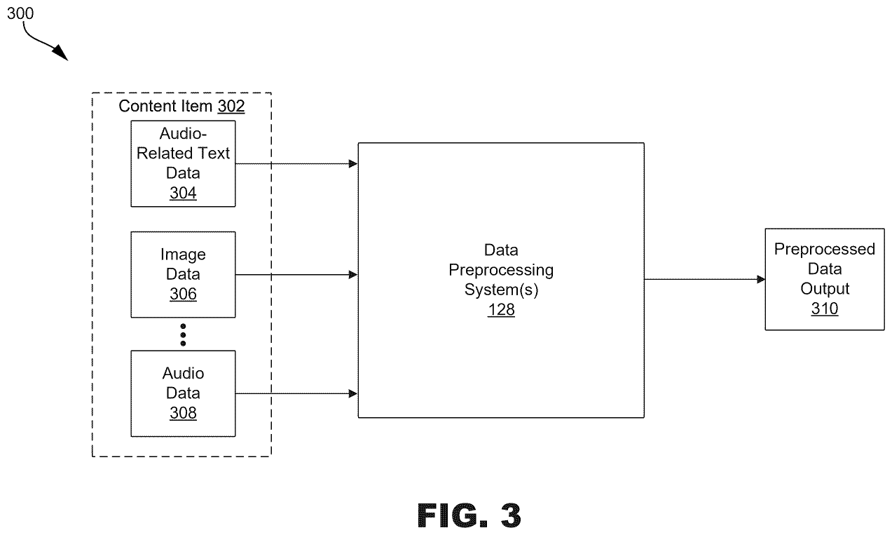

FIG. 3 is a diagram illustrating an example system 300 for preprocessing audio-related text data associated with a content item 302, according to some examples of the present disclosure. The content item 302 can include, for example and without limitation, a movie, a television show, a video and/or audio podcast, a video game, a video animation, a broadcast (e.g., video broadcast, radio broadcast, etc.), music, etc. As shown in FIG. 3, the audio-related text data 304 can be fed to the data preprocessing system(s) 128 as input to the data preprocessing system(s) 128. The data preprocessing system(s) 128 can preprocess the audio-related text data 304 associated with the content item 302 (and, optionally, other data) to generate preprocessed data output 310.

In some cases, to generate the preprocessed data output 310, the data preprocessing system(s) 128 can optionally receive other data inputs such as, for example and without limitation, image data 306 and/or audio data 308 associated with the content item 302. For example, in addition to the audio-related text data 304, the input to the data preprocessing system(s) 128 can optionally include the image data 306 and/or the audio data 308 associated with the content item 302. The data preprocessing system(s) 128 can then generate the preprocessed data output 310 based on the audio-related text data 304 and, optionally, further based on the image data 306 and/or audio data 308.

The data preprocessing system(s) 128 can include any model, algorithm, server, and/or processing system. In some examples, the data preprocessing system(s) 128 can include an AI/ML model, such as a neural network model, and/or any other algorithm. Moreover, the audio-related text data 304 can include any text associated with the content item 302. For example, the audio-related text data 304 can include or represent text generated from and/or corresponding to an audio (e.g., audio data 308) of the content item 302, such as closed captions and/or subtitles. The image data 306 can include one or more video frames, one or more still images (e.g., one or more pictures, photographs, drawings, illustrations, screenshots, raster images, vector images, raw images, color images, grayscale images, binary images, two-dimensional (2D) images, three-dimensional (3D) images, synthetic or computer-generated images, display and/or rendered/rendering data, etc.), one or more files or data structures having and/or encoding visual/visualization information (e.g., pixel values; red, green, and blue (RGB) values/components; etc.), one or more animations, graphics, rendering data, and/or any other visual data.

The audio data 308 can include any audio/acoustic signal(s), channel(s), component(s), waveform(s), data, information, audio sample data or sampled audio, data structure(s) (e.g., a file, container, clip, data block, etc.), and/or features. In some aspects, the audio data 308 can include, for example and without limitation, speech, one or more voices, one or more noises, one or more sounds, dialogue, music, silence, one or more audio recordings, one or more audio waveforms, etc. The preprocessed data output 310 can include any text and/or text data representation (e.g., one or more text and/or word embeddings, vectorized text, etc.) associated with the content item 302. For example, the preprocessed data output 310 can include any text extracted and/or generated/determined from the audio-related text data 304, such as a text transcription and/or translation (e.g., closed captions, subtitles, etc.) of audio (e.g., audio data 308) obtained and/or determined from the audio-related text data 304.

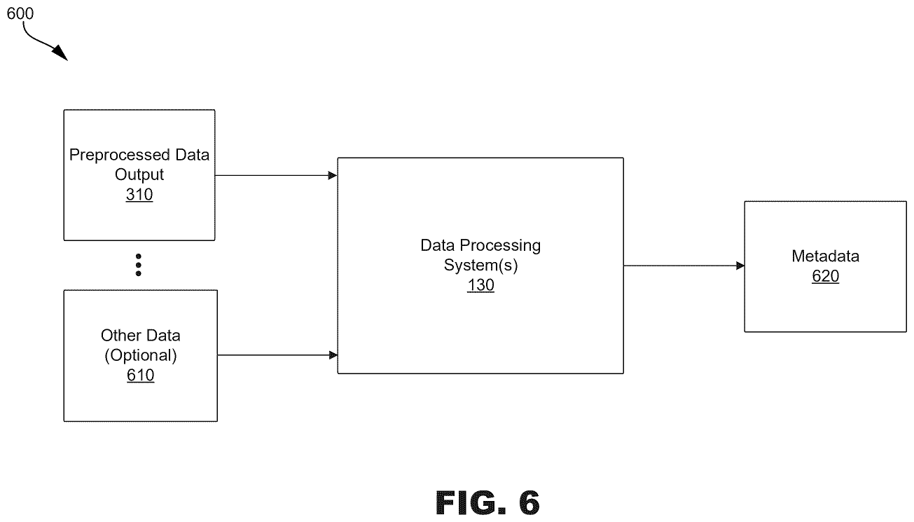

In some aspects, the preprocessed data output 310 can additionally or alternatively include any other text data such as, for example and without limitation, metadata, comments, tags, text generated from any of the inputs to the data preprocessing system(s) 128 (e.g., text from the audio-related text data 304, the image data 306, and/or the audio data 308), context information, descriptive data, and/or additional details about the content item 302. For instance, the preprocessed data output 310 can include information about the content item 302 conveyed in the audio-related text data 304 and any other information associated with the content item 302 such as context information, additional details about the content item 302, metadata, etc. In some cases, the preprocessed data output 310 can include a representation of text associated with the preprocessed data output 310. For example, in some cases, the preprocessed data output 310 can include text/word embeddings that can be processed as an input to the data processing system(s) 130 to generate an output, such as metadata, as further described below with respect to FIG. 6.

In some examples, the preprocessed data output 310 can include a version of the audio-related text data 304 that is modified to include additional information such as context information, additional information about the content item 302, metadata, content information, etc. In some cases, the preprocessed data output 310 can additionally or alternatively include a version of the audio-related text data 304 that is reorganized and/or reformatted (e.g., rearranged, reordered, restructured, etc.) in a particular way. For example, the preprocessed data output 310 can include text from the audio-related text data 304 that is organized, grouped, and/or arranged based on topics, timelines, events, time sequences, etc. In some examples, the preprocessed data output 310 can include closed captions and/or subtitles from the audio-related text data 304 and any other information as described herein, and can be configured according to a particular sequence, such as a chronological order.

As further described herein, in some cases, the data preprocessing system(s) 128 can optionally use the image data 306 and/or the audio data 308 to extract and/or obtain any other information associated with the content item 302 in addition to information it extracts, generates, and/or obtains from the audio-related text data 304 (e.g., additional information) such as, for example and without limitation, context information, formatting information, information used to determine a configuration for the preprocessed data output 310 (e.g., information used to determine how to organize, arrange, order, group, sequence, format, and/or structure the preprocessed data output 310), event information, supplemental information, metadata, activity information, character/actor information, content information, auxiliary/ancillary information, and/or any other information as described herein). The data preprocessing system(s) 128 can include any of such information in the preprocessed data output 310 (e.g., in addition to any information from the audio-related text data 304), and/or can use such information to organize (e.g., arrange, order, group, serialize, etc.) the text information in the preprocessed data output 310, as further described herein.

For example, the data preprocessing system(s) 128 can include text information from the audio-related text data 304 in the preprocessed data output 310, and can add any information extracted, determined, and/or generated from the image data 306 and/or the audio data 308 to the preprocessed data output 310 and/or configure the preprocessed data output 310. The addition of such information to the preprocessed data output 310 and/or the use of such information to configure the preprocessed data output 310 can increase the total amount of information associated with the content item 302 in the preprocessed data output 310; increase the accuracy of information in the preprocessed data output 310; provide (or increase) contextual information included in the preprocessed data output 310; expand and/or clarify any of the details in the preprocessed data output 310; improve a system's ability to process the preprocessed data output 310 and/or extract information therefrom; enable a system to use the preprocessed data output 310 to generate more meaningful, complete, relevant, informative, detailed, valuable, and/or accurate information (e.g., metadata, content previews, content recaps, advertisements, etc.) and/or content experiences; fill gaps of information/knowledge in the preprocessed data output 310; filter out of the preprocessed data output 310 less relevant, valuable, desired, necessary, or important information from the audio-related text data 304; increase an intelligibility and/or readability of the information in the preprocessed data output 310; increase a quality, relevance, descriptiveness, and/or coverage of information in the preprocessed data output 310; and/or otherwise enrich, improve, and/or enhance the preprocessed data output 310, among other things.

In an illustrative example, the data preprocessing system(s) 128 can use image data 306 and/or audio data 308 from the content item 302 to generate information associated with the content item 302 in addition to any information obtained from, and/or generated based on, the audio-related text data 304. The data preprocessing system(s) 128 can include such information in the preprocessed data output 310, along with any text information from the audio-related text data 304. For example, the data preprocessing system(s) 128 can use the image data 306 and/or the audio data 308 to extract and/or determine information (e.g., in addition to the information in the audio-related text data 304) about the content item 302, the audio-related text data 304, and/or a context associated with the content item 302 and/or the audio-related text data 304. The data preprocessing system(s) 128 can include any of that information in the preprocessed data output 310 (e.g., in addition to information from the audio-related text data 304) in order to enhance, expand, and/or supplement the information obtained and/or generated from the audio-related text data 304 and included in the preprocessed data output 310 (e.g., in order to increase the amount of relevant information included in the preprocessed data output 310).

In some cases, the data preprocessing system(s) 128 can include in the preprocessed data output 310 information obtained from (and/or based on) the audio-related text data 304, the image data 306, and/or the audio data 308 to provide context and/or any other relevant information about a deviation in a timeline of the content item 302 and/or associated content. For example, the timeline of a content item can include one or more deviations. A deviation in the timeline of the content item 302 can occur when a portion(s) of the timeline follows a chronology (e.g., a series of events, ideas, time windows or periods, and/or content that occur and/or are provided/presented in an order, such as an order in which they occurred/happened or were created) or chronological order while another portion(s) of the timeline does not follow the chronology or chronological order. For example, in some cases, the timeline of the content item 302 can follow a particular order, such as a logical, sequential, or chronological order; that arranges content and/or events logically, sequentially, or chronologically. When there is a deviation in the timeline of the content item 302, the timeline can jump from a content, event, or time/period in the timeline to another content, event, or time/period that does not follow the correct, specific, or predetermined order of content, events, and/or times/periods in the timeline, such as the logical, sequential, or chronological order of content, events, and/or times/periods. In some cases, after the deviation, the timeline of the content item 302 may or may not return to the correct, specific, or predetermined order of content, events, and/or times/periods.

Non-limiting examples of deviations in a timeline can include a flashback, a flashforward, and a recap sequence (e.g., a “recap”). A flashback can refer to a situation or event where the timeline moves/shifts to a point in the past. For example, a flashback can be used to provide/present a scene that moves/shifts the narrative or story associated with the content item 302 back in time from a particular point of the narrative or story. In some examples, the flashback can be used to recount events that happened in the past, such as events that happened before the story's primary sequence of events and/or events that happened at an earlier point in time within the timeline. A flashforward can refer to a situation or event where the timeline moves/shifts to a point in the future. For example, a flashforward can be used to reveal events that will occur in the future, such as a scene that temporarily moves/shifts the narrative or story forward in time from a particular point of the narrative or story. A recap can refer to a narrative device that provides, presents, explains, highlights, and/or summarizes content from a previous period(s) in the timeline of the content item 302. For example, a recap can present content from a previous episode or segment to explain something(s) that already happened in the narrative or story and bring the user up-to-date.

In some cases, when there is a deviation in a timeline of the content item 302, the information in the audio-related text data 304 may lack (or have limited or insufficient amount of) context information, information that may help better understand the deviation and/or associated content, and/or any other details that may further explain/describe the deviation, the content associated with the deviation. Thus, as further described herein, the data preprocessing system(s) 128 can add, to the preprocessed data output 310, information obtained from (and/or based on) the audio-related text data 304, the image data 306, and/or the audio data 308 in order to provide context and/or any other relevant information about the deviation in the timeline of the content item 302 and/or the associated content.

For example, assume that the audio-related text data 304 includes a transcription (e.g., closed captions) of dialogue from a flashback scene in the content item 302 (e.g., a scene from the past corresponding to a flashback in the content item where the content or timeline in the content item goes back in time), which represents a deviation in the timeline of the content item 302. In this example, the transcription may include the content of the dialogue but may not include other relevant information about the dialogue and/or the flashback scene, such as an identity and/or a sentiment of a character(s) involved in the dialogue. Moreover, in some cases, such information may not be inferred and/or otherwise determined from the dialogue. As such, in this example, while the data preprocessing system(s) 128 may be able to determine the content of the dialogue from the audio-related text data 304, the data preprocessing system(s) 128 may not be able to determine the identity and/or sentiment of the character(s) from the audio-related text data 304 (or the dialogue included in the audio-related text data 304). Thus, the data preprocessing system(s) 128 may not be able to extract such information from the audio-related text data 304 in order to include it in the preprocessed data output 310. As a result, the preprocessed data output 310 may lack some relevant information about the content item 302 (e.g., the identity and/or sentiment of the character(s)) that, if otherwise included in the preprocessed data output 310, may increase the value, accuracy, completeness/comprehensiveness, and/or specificity of the preprocessed data output 310. Consequently, such information may not be included, reflected, encoded, captured, described, represented, and/or encompassed in other data generated from (and/or based on) the preprocessed data output 310, such as metadata for the content item 302 generated from the preprocessed data output 310 as further described herein.

However, in the above example, the data preprocessing system(s) 128 may be able to extract and/or determine such information from the image data 306 and/or the audio data 308 in order to include such details in the preprocessed data output 310 (along with the dialogue from the audio-related text data 304 and/or any other information from the audio-related text data 304), which can allow such details to be included, reflected, encoded, represented, and/or described in any other data generated from (and/or based on) the preprocessed data output 310, such as context-aware metadata generated from the preprocessed data output 310 as illustrated in FIG. 6. For example, the data preprocessing system(s) 128 can process a portion of the image data 306 that corresponds to the flashback scene and use facial recognition on the image data 306 to determine the identity of the character(s) involved in the dialogue. Similarly, the data preprocessing system(s) 128 can additionally or alternatively process a portion of the audio data 308 that corresponds to the flashback scene and use voice recognition on the audio data 308 to determine the identity of the character(s) involved in the dialogue. The data preprocessing system(s) 128 may then add, to the preprocessed data output 310, any information extracted from the image data 306 and/or the audio data 308 about the identity of the character(s) involved in the dialogue. Accordingly, in this example, the preprocessed data output 310 may include the dialogue from the audio-related text data 304 (and/or any other relevant information included in the audio-related text data 304) as well as information about the identity of the character(s) involved in the dialogue, which as noted above can be obtained from the image data 306 and/or the audio data 308.

As another example, the data preprocessing system(s) 128 can process a portion of the image data 306 that corresponds/correspond to the flashback scene to perform video/image sentiment analysis and/or gesture recognition based on that portion of the image data 306, in order to determine (e.g., based on the sentiment analysis and/or gesture recognition) a sentiment, emotion, and/or tone of the character(s) involved in the dialogue, as conveyed, reflected, and/or communicated in that portion of the image data 306. Similarly, the data preprocessing system(s) 128 can additionally or alternatively process a portion of the audio data 308 that corresponds to the flashback scene to perform audio sentiment analysis and/or emotion recognition based on voice/speech data in the audio data 308, in order to determine (e.g., based on the audio sentiment analysis and/or emotion recognition) the sentiment, tone, and/or emotion of the character(s) involved in the dialogue, as conveyed, reflected, and/or communicated in that portion of the audio data 308. The data preprocessing system(s) 128 may add, to the preprocessed data output 310, any information extracted from the image data 306 and/or the audio data 308 about the sentiment, tone, and/or emotion of the character(s) involved in the dialogue, in addition to the dialogue and/or any other relevant information included in the preprocessed data output 310 from the audio-related text data 304.

As yet another example, if the content item 302 includes a recap or flashback provided using a previous/past video frame(s) from a sequence of video frames of the content item 302 (e.g., a video frame(s) from a previous time/period within a sequence of video frames of the content item 302, relative to a time/period within the sequence that includes the recap or flashback and/or that is associated with a deviation in a timeline of the content item 302 where the content item 302 goes back to a previous time/period along the timeline corresponding to the recap or flashback), the portion of the audio-related text data 304 corresponding to the recap or flashback may not indicate or signal (e.g., at least without additional processing and/or information) that the video frame(s) used to provide the recap or flashback is a previous/past video frame(s) extracted from an earlier portion of the sequence of video frames of the content item 302.

In other words, the portion of the audio-related text data 304 corresponding to the recap or flashback may not indicate that the video frame(s) used to provide the recap or flashback is a video frame(s) from the past in relation to a timeline of the content item 302 and/or the sequence of video frames of the content item 302 (e.g., the portion of the audio-related text data 304 may not indicate that such video frame(s) is from a previous time/period within the sequence of video frames of the content item 302 relative to a time/period within the sequence that includes or triggers the recap or flashback and/or that includes a deviation in the timeline of the content item 302 (a deviation corresponding to the recap or flashback) where the content item 302 goes back to in time along the timeline of the content item 302. Thus, the data preprocessing system(s) 128 may recognize from the audio-related text data 304 that the video frame(s) used to provide the recap or flashback is a previous/past video frame(s) as described above.

However, in this example, the data preprocessing system(s) 128 can use the image data 306 to perform frame recognition or video stream recognition to determine that the video frame(s) associated with the recap or flashback is/are a previous/past frame(s). For example, the data preprocessing system(s) 128 can use frame recognition or video stream recognition to match the video frame(s) used for the recap or flashback with a previous video frame(s) along the sequence of video frames of the content item 302 (e.g., a previous video frame(s) along the timeline of the content item 302), and determine (e.g., based on a match or a similarity threshold) that the video frame(s) used for the recap or flashback is a previous frame(s) from a previous time/period along the timeline of the content item 302 (e.g., a previous video frame(s) being reused for the recap or flashback from a previous portion of the sequence).

In response to detecting that the video frame(s) used for the recap or flashback is a previous frame(s), the data preprocessing system(s) 128 can extract and/or obtain additional information about the recap or flashback from a portion(s) of the audio-related text data 304 (e.g., from a portion of the audio-related text data 304 corresponding to a particular period/time along a timeline of the content item 302 that is before and/or after the content included in the recap or flashback is located (and/or took place) within the timeline (e.g., a particular period/time that is adjacent to (before and/or after) a different period/time along the timeline associated with the content included in the recap/flashback and/or is within a particular distance along the timeline before or after the different period/time along the timeline associated with the content included in the recap/flashback), the image data 306 (e.g., a portion of the image data 306 corresponding to the recap/flashback and/or a time/period along the timeline of the content item 302 that is before and/or after a portion of the timeline corresponding to the content in the recap/flashback). The data preprocessing system(s) 128 can include such information in the portion of the preprocessed data output 310 corresponding to the recap or flashback (e.g., as context information and/or other information included in addition to any other information extracted and/or generated for that portion of the preprocessed data output 310 from the audio-related text data 304).

For example, the data preprocessing system(s) 128 can extra information associated with the recap or flashback from the previous video frame(s), from a portion of the audio data 308 corresponding to the previous video frame(s) and the recap or flashback, from one or more other video frames before and/or after the previous video frame(s) in the sequence (e.g., one or more adjacent video frames within the sequence), and/or from a portion(s) of the audio-related text data 304 and/or the audio data 308 corresponding to one or more other/adjacent video frames before and/or after the previous video frame(s). The data preprocessing system(s) 128 can include such information in a portion of the preprocessed data output 310 corresponding to the recap or flashback, in addition to any other information included in the preprocessed data output 310 from the audio-related text data 304 (e.g., from a portion of the audio-related text data 304 corresponding to the recap or flashback). This way, the data preprocessing system(s) 128 can increase the amount of information in the preprocessed data output 310 pertaining to the recap or flashback, beyond the information extracted, determined, inferred, and/or generated from the portion of the audio-related text data 304 corresponding to the recap or flashback.

In some examples, the data preprocessing system(s) 128 can additionally or alternatively process the audio data 308 to perform audio matching and/or recognition, which the data preprocessing system(s) 128 can use to determine whether the portion of the audio-related text data 304 and/or video frame(s) corresponding to the recap or flashback is/are from the past (e.g., from a previous time along the timeline of the content item 302 and/or a previous/past video frame(s) within the sequence of video frames associated with the content item 302). The data preprocessing system(s) 128 can then extract or determine associated information from one or more portions of the audio-related text data 304, the image data 306, and/or the audio data 308 corresponding to the recap or flashback and/or one or more segments before and/or after the recap or flashback (e.g., one or more adjacent segments along the sequence). The data preprocessing system(s) 128 can include such information in the preprocessed data output 310 along with any other information obtained from the portion of the audio-related text data 304 corresponding to the recap or flashback.

In some cases, the data preprocessing system(s) 128 can additionally or alternatively process the image data 306 to perform scene recognition to determine whether a scene from a video frame(s) corresponding to the portion of the audio-related text data 304 associated with the recap or flashback is/are from the past (e.g., from a previous time along the timeline of the content item 302 and/or the sequence of video frames associated with the content item 302). If the data preprocessing system(s) 128 determines from the scene recognition that the scene associated with the recap or flashback is a previous scene (e.g., a scene from a previous video frame(s) within the sequence of video frames and/or from a previous time/period along the timeline of the content item 302), the data preprocessing system(s) 128 can determine that the recap or flashback involves a deviation in the timeline of the content item 302 and can process a portion of the audio-related text data 304, the image data 306, and/or the audio data 308 associated with the deviation in the timeline (and/or associated with a time/period before and/or after such deviation in the timeline) to extract or determine additional information (e.g., in addition to any information from a corresponding portion of the audio-related text data 304) about the recap or flashback. The data preprocessing system(s) 128 can include such information in a portion of the preprocessed data output 310 corresponding to the recap or flashback, along with any other information obtained from the portion of the audio-related text data 304 corresponding to the recap or flashback.

In some cases, the data preprocessing system(s) 128 can use any portion of the audio-related text data 304, the image data 306, and/or the audio data 308 to detect when there is a deviation in the timeline of the content item 302. For example, the data preprocessing system(s) 128 can use the image data 306 to perform facial recognition and identify a character in a scene depicted in the image data 306. Based on the identified character, the data preprocessing system(s) 128 can determine that the scene corresponds to a deviation in the timeline. To illustrate, if the identified character is a character from a previous scene, the data preprocessing system(s) 128 can determine that the presence of such character in the scene indicates that the scene corresponds to a deviation in the timeline. If the identified character is a younger version of a particular character in a story, the data preprocessing system(s) 128 may determine that the scene corresponds to a flashback since the character in the scene is a younger version of a particular character in the story.

As another example, the data preprocessing system(s) 128 can use the image data 306 to perform scene recognition, frame recognition, and/or video stream recognition. The data preprocessing system(s) 128 can detect a deviation in the timeline based on the recognition results. For example, the data preprocessing system(s) 128 can determine that a video frame in the image data 306 is the same as a previous video frame, and determine that the recognized video frame corresponds to a deviation in the timeline. If the scene recognition identifies a scene from the past, the data preprocessing system(s) 128 can determine that the recognized scene corresponds to a deviation in the timeline.

In some cases, the data preprocessing system(s) 128 can use the image data 306 to detect other cues that indicate a deviation in the timeline. For example, the data preprocessing system(s) 128 may detect, from the image data 306, that a scene depicts certain colors (e.g., black and white, etc.) and/or visual patterns that indicate or represent a deviation in the timeline, such as a flashback. Thus, the data preprocessing system(s) 128 may determine that the scene corresponds to a deviation in the timeline. In other examples, the data preprocessing system(s) 128 may detect certain objects in a scene that indicate or suggest a deviation in the timeline, such as a flashback or a flashforward. For example, if the data preprocessing system(s) 128 detect certain objects from a past or future time, such as a landmark that no longer exists or a futuristic object, the data preprocessing system(s) 128 may determine that the scene depicting such objects corresponds to a deviation in the timeline.

In some examples, the data preprocessing system(s) 128 can use the audio data 308 to perform speech recognition and/or voice recognition to similarly detect a deviation in the timeline. To illustrate, if the voice recognition identifies a voice in the audio data 308 that corresponds to a younger version of a character in the story, the data preprocessing system(s) 128 can determine that the content associated with that portion of the audio data 308 corresponds to a deviation in the timeline, as it includes the voice of the younger version of the character in the story. If the speech recognition identifies a particular utterance by a character in the story from a previous point in the story, the data preprocessing system(s) 128 can determine based on the identified utterance that the content associated with that portion of the audio data 308 corresponds to a deviation in the timeline.

Moreover, the data preprocessing system(s) 128 can use the audio data 308 to detect other cues that indicate a deviation in the timeline. For example, the data preprocessing system(s) 128 may detect, from the audio data 308, certain sounds, voices, utterances, or noises that indicate or represent a deviation in the timeline, such as a flashback, a recap, or a flashforward. Thus, the data preprocessing system(s) 128 may determine that the audio data 308 corresponds to a deviation in the timeline.

As previously described, if the data preprocessing system(s) 128 detects a deviation in the timeline associated with a portion of the audio-related text data 304, the data preprocessing system(s) 128 can process one or more portions of the image data 306, one or more portions of the audio data 308, and/or other portions of the audio-related text data 304 to obtain additional, relevant information about the deviation in the timeline to include in the preprocessed data output 310 along with any information included in the preprocessed data output 310 from the portion of the audio-related text data 304 corresponding to the deviation in the timeline. For example, if the data preprocessing system(s) 128 detects a deviation in the timeline associated with a portion of the audio-related text data 304, the data preprocessing system(s) 128 can process a portion of the image data 306 corresponding to the deviation in the timeline, a portion of the audio data 308 corresponding to the deviation in the timeline, and/or a portion of the audio-related text data 304 corresponding to a period(s) before and/or after the deviation in the timeline, in order to obtain additional information (e.g., in addition to any information in the corresponding portion of the audio-related text data 304) that the data preprocessing system(s) 128 can include with the information from that portion of the audio-related text data 304 in the preprocessed data output 310.

To illustrate, the data preprocessing system(s) 128 can use the image data 306 and/or audio data 308 to extract information about the scene from the deviation in the timeline and/or characters in the scene. The data preprocessing system(s) 128 can include in the preprocessed data output 310 any information from the audio-related text data 304 corresponding to the deviation in the timeline, and supplement such information with the information about the scene and/or the characters in the scene extracted from the image data 306 and/or the audio data 308.

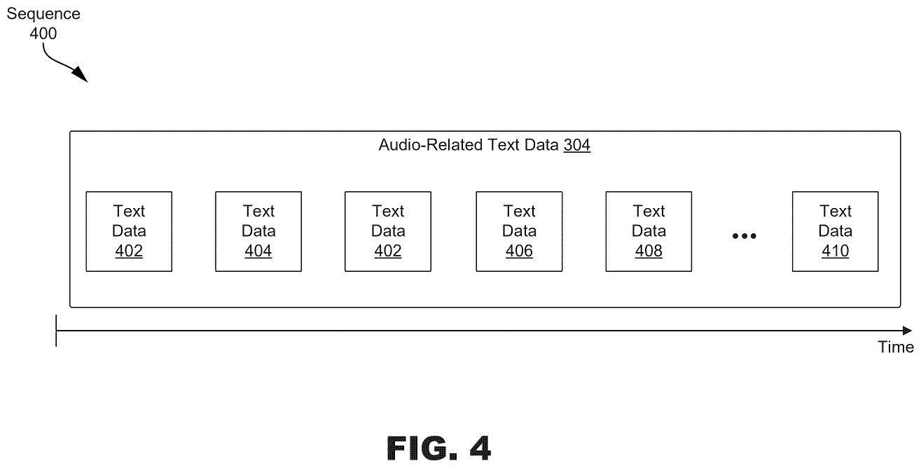

FIG. 4 is a diagram illustrating an example sequence 400 of the audio-related text data 304, according to some examples of the present disclosure. The audio-related text data 304 can include a particular order or sequence of the text data, such as a chronological order in which an audio (e.g., audio data 308) used to generate the audio-related text data 304 occurred within a timeline of the content item 302. In this example, the sequence 400 can correspond to an order or sequence of content item data associated with the text data 402-410 in the audio-related text data 304, such as an order or sequence of video frames and associated audio of the content item used to generate the audio-related text data 304.

In some aspects, the text data 402-410 can include transcriptions or translations of dialogue (and/or any other audio) in the content item 302 (e.g., in the audio data 308), such as closed captions and/or subtitles. In some examples, the sequence 400 of the text data 408-410 can reflect, include, and/or represent an order in which the dialogue used to generate the text data 402-410 occurred within the timeline of the content item 302. In FIG. 4, the audio-related text data 304 includes two instances of the text data 402. The first instance of the text data 402 (e.g., the instance prior to the text data 404 along the timeline of the content item 302) can represent the first instance of a dialogue that occurred in the timeline, and the second instance of the text data 402 (e.g., the instance after the text data 404 and before the text data 406) can represent a flashback that recounts the dialogue associated with the text data 402.

As further described herein, when generating the preprocessed data output 310, the data preprocessing system(s) 128 can, in some cases, organize the information in the preprocessed data output 310 (e.g., including information from and/or generated based on the text data 402-410) in a manner that improves the storyline conveyed by the information in the preprocessed data output 310 and/or correlates, enhances, expands, bolsters, and/or groups relevant information from the preprocessed data output 310 (e.g., including any information obtained from the text data 402-410) and/or relationships of information in the preprocessed data output 310.

The organization/reorganization of the information in the preprocessed data output 310 can increase the amount, quality, clarity, and/or descriptiveness of the information in the preprocessed data output 310; bolster or increase the readability, intelligibility, completeness, and/or clarity of information in the preprocessed data output 310 and/or the storyline conveyed by the information in the preprocessed data output 310; correlate, enhance, expand, and/or group relevant information from the preprocessed data output 310 and/or relationships of information in the preprocessed data output 310; etc. For example, the organization/reorganization of the information in the preprocessed data output 310 can arrange the information in a way that creates a more clear, descriptive, complete, and/or informative storyline conveyed by the organized/reorganized information in the preprocessed data output 310.

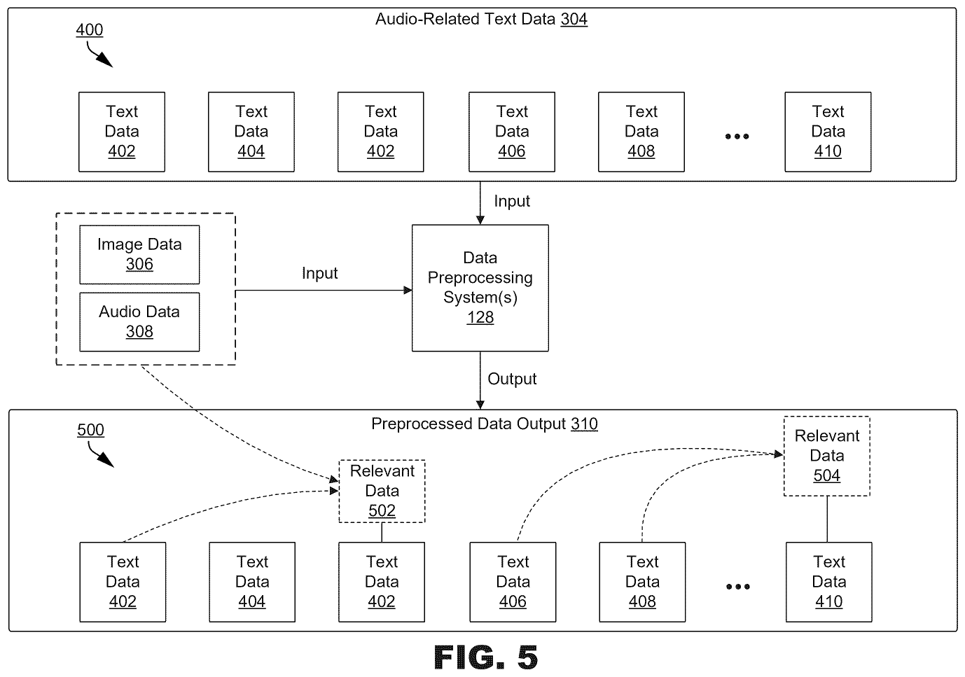

FIG. 5 is a diagram illustrating an example organization 500 of the preprocessed data output 310 generated by the data preprocessing system(s) 128 from the audio-related text data 304, according to some examples of the present disclosure. The data preprocessing system(s) 128 can receive the audio-related text data 304 as input (as well as the image data 306 and/or the audio data 308, as previously described) and generate the preprocessed data output 310. In generating the preprocessed data output 310, the data preprocessing system(s) 128 can organize the information in the preprocessed data output 310 based on one or more organization schemes such as, for example and without limitation, based on topics, timelines, sequences, events, timestamps, series, segments, content, relationships/correlations, and/or any other factor and/or scheme. In the example shown in FIG. 5, the preprocessed data output 310 includes the text data 402-410 from the audio-related text data 304 as well as other relevant data added by the data preprocessing system(s) 128, and reflects an organization 500 of the data that organizes and groups certain portions of the data in the preprocessed data output 310.

For example, some of the text data 402-410 in the preprocessed data output 310 is organized in a chronological order as reflected in the sequence 400 shown in FIG. 4. However, the second instance of the text data 402 corresponds to a flashback and thus represents a deviation in the timeline of the content item 302. In addition, the second instance of the text data 402 is grouped with relevant data 502 and the text data 410 is grouped with relevant data 504. In this example, the relevant data 502 grouped with the second instance of the text data 402 is obtained from and/or generated based on the image data 306 and/or the audio data 308, which may include relevant information about the snapshot associated with the second instance of the text data 402. The relevant data 504 grouped with the text data 410 is obtained from and/or generated based on at least a portion of the text data 406 and the text data 418. In some examples, the relevant data 504 can include all or some of the text data 406 and all or some of the text data 408. In other examples, the relevant data 504 can additionally or alternatively include information inferred, determined, and/or generated from the text data 406 and the text data 408.

In some implementations, grouping relevant data together can include stitching, fusing, and/or combining the data together. For example, in FIG. 5, the second instance of the text data 402 and the relevant data 502 can be stitched together to form a combination of stitched data where the portions of stitched data (e.g., the second instance of the text data 402 and the relevant data 502) have some relevance, correlation, and/or relationship with/to each other and/or otherwise compliment and/or supplement each other. Similarly, the text data 410 and the relevant data 504 can be stitched together to form a combination of stitched data where the portions of stitched data (e.g., the text data 410 and the relevant data 504) similarly have some relevance, correlation, and/or relationship with/to each other and/or otherwise compliment and/or supplement each other.

In some cases, the relevant data 502 associated with the second instance of the text data 402 can include information that is relevant to and/or correlated with the snapshot, and the relevant data 504 associated with the text data 410 can include information that is relevant to and/or correlated with the text data 410. Because the relevant data 502 includes information that is relevant to and/or correlated with the snapshot, the relevant data 502 can be grouped and/or correlated with the second instance of the text data 402 corresponding to the snapshot. The grouping and/or correlation of the relevant data 502 with the second instance of the text data 402 can provide more information about and/or relevant to the snapshot than the text data 402 alone (e.g., without the relevant data 502). In some aspects, the relevant data 502 can provide a context associated with the snapshot (e.g., associated with the second instance of the text data 408) and/or information about a topic, subject, story, event, activity, character, object, condition, message, story, and/or content associated with the snapshot.

For example, assume that the text data 402 includes a transcription and/or translation of speech from a character during the flashback (as well as the scene associated with the first instance of the text data 402 where the speech first occurred during the timeline of the content item 302). The transcription and/or translation of speech in the text data 402 can convey the speech and may convey some information about the flashback, the character, and/or any other information, but may lack more/other details about the flashback, the character, the speech of the character, a context of the flashback and speech, and/or any other details that may further explain, clarify, and/or describe any aspect of the flashback, character, speech, and/or associated content.

On the other hand, the relevant data 502 may provide other/additional details about the flashback, the character, the speech of the character, a context of the flashback and speech, and/or the content associated with the snapshot and the text data 402. For example, the relevant data 502 may further explain, clarify, and/or describe any aspect of the flashback, character, speech, and/or associated content, and may consequently allow more details/information associated with the flashback, content of the flashback, character, speech, and/or content item 302 to be extracted, determined, and/or inferred from the second instance of the text data 402 and the relevant data 502 (e.g., from the grouping of the text data 408 and the relevant data 502) associated with the flashback. In some implementations, the second instance of the text data 402 together with the relevant data 502 may allow the data processing system(s) 130 to generate more complete, accurate, relevant, descriptive, specific, valuable, diverse, and/or informative metadata associated with the flashback, such as context-aware metadata associated with the flashback.

To illustrate, the relevant data 502 grouped with the second instance of the text data 402 may capture additional information about the flashback. For example, the relevant data 502 may describe a context of the flashback. The context of the flashback can provide information about, for example and without limitation, a scene of the flashback; a condition associated with the flashback; a location of the flashback; activity during the flashback; an event or a series of events that occurred during, before, and/or after the flashback; information about the character associated with the flashback, such as an identity of the character, a condition associated with the character, an action taken by the character, etc.; a topic of the flashback; and/or any other context information. Thus, while the second instance of the text data 408 can provide the speech of the character during the flashback and can thus convey certain information about the flashback, the relevant data 502 grouped with the second instance of the text data 402 can provide additional information associated with the flashback, such as the context of the flashback.

In some examples, the text data 410 may include a dialogue associated with a recap, and the relevant data 504 may include additional information about and/or from the recap. For example, the relevant data 504 can include information about a context of the dialogue and/or the recap, such as information about a scene associated with the dialogue, information about any characters in the scene such as any characters associated with the dialogue, information about a series of events associated with the recap, etc. The relevant data 504 can thus explain, clarify, and/or describe any aspect of the recap, dialogue, and/or associated content, and may consequently allow more details/information associated with the recap, content of the recap, dialogue, and/or content item 302 to be extracted, determined, and/or inferred from the text data 410 and the relevant data 504 (e.g., from the grouping of the text data 410 and the relevant data 504) associated with the recap. In some implementations, the text data 410 together with the relevant data 504 may allow the data processing system(s) 130 to generate more complete, accurate, relevant, descriptive, specific, valuable, diverse, and/or informative metadata associated with the recap, such as context-aware metadata associated with the recap.

In the previous examples, the organization 500 maintains a sequence of the text data and, when there is a deviation in the timeline such as a flashback or recap, the text data is grouped with other data that provides additional information about the deviation in the timeline and/or the associated content. In other examples, the data preprocessing system(s) 128 can move any text data within other portions of the timeline of the content item 302 to create a storyline stitching together relevant portions of data. For example, the data preprocessing system(s) 128 can move the text data corresponding to a deviation in the timeline to a corresponding location within the timeline so the data corresponding to the deviation in the timeline is grouped with other, relevant data within a same portion(s) of the timeline.

FIG. 6 is a diagram illustrating an example system process 600 for using the preprocessed data output 310 from the data preprocessing system(s) 128 to generate metadata 620 associated with the content item 302, according to some examples of the present disclosure. The preprocessed data output 310 can be fed to the data processing system(s) 130 as an input used by the data processing system(s) 130 to generate the metadata 620. In some cases, the data processing system(s) 130 can optionally use other data 610 as input to generate the metadata 620, in addition to the preprocessed data output 310.

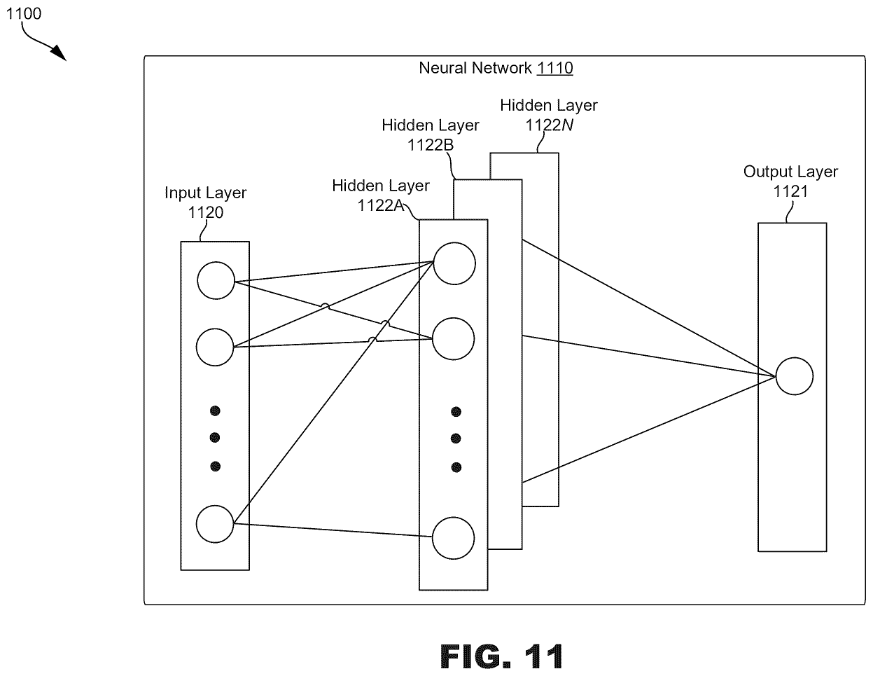

The other data 610 can include any other data associated with the content item 302, such as the image data 306 (or a portion thereof) and/or the audio data 308 (or a portion thereof) associated with the content item. The data processing system(s) 130 can include an algorithm(s) and/or model(s) configured to generate metadata from text data inputs (and, optionally, any other inputs), such as an AI/ML model. In an illustrative example, the data processing system(s) 130 can include a large language model (LLM) configured to generate metadata as described herein. In some cases, the data processing system(s) 130 can include one or more neural networks, such as a transformer, a convolutional neural network (CNN), an encoder-decoder network, an encoder-only network, a decoder-only network, a mixture of experts (MoE) network, a generative model network, or any other neural network. An example neural network architecture that can be used to implement the data processing system(s) 130 (and/or any other system described herein, such as the data preprocessing system(s) 128) is illustrated in FIG. 11 and further described below with respect to FIG. 11.

The data processing system(s) 130 can analyze the preprocessed data output 310 to extract, infer, generate, and/or determine information about the content item 302 that the data processing system(s) 130 can use to generate the metadata 620. For example, the data processing system(s) can use the preprocessed data output 310 to determine, infer, and/or extract one or more topics, genres, interactive advertising bureau (IAB) content categories, actors, characters, events, contexts, languages, subjects, conditions, and/or characteristics associated with the content item 302. In this example, the data processing system(s) can use the one or more topics, genres, interactive advertising bureau (IAB) content categories, actors, characters, events, contexts, languages, subjects, conditions, and/or characteristics associated with the content item 302 to generate the metadata 620 associated with the content item 302.

To illustrate, in some cases, the preprocessed data output 310 can include a transcription or translation of any speech and/or dialogue in the content item 302 as well as context information added to the preprocessed data output 310, as previously described. The data processing system(s) 130 can use the transcription or translation of speech and/or dialogue in the content item 302 and the context information to determine information about the content item 302, such as information about one or more scenes in the content item 302, one or more actors associated with the content item 302, a genre associated with the content item 302, one or more topics associated with the content item 302, one or more events associated with the content item 302, one or more categories associated with the content item 302, etc. The data processing system(s) 130 can use such information to generate the metadata 620. In some examples, the data processing system(s) 130 can identify any of such information based on a content, tone, semantic meaning, and/or cues in any of the speech and/or dialogue associated with the preprocessed data output 310.

In some cases, the metadata 620 generated by the data processing system(s) 130 can represent context-aware metadata that includes information about the content item 302 and a context associated with the content item 302. In some examples, the metadata 620 can include a title, genre, description, director, actor, event, IAB category, character, mood, language, episode, frame rate, image size, codec, keyword, scene, size, sentiment, length, rating/ranking, type, produce, star, plot, synopsis, credits, thumbnail, tag, context, name, cover, trailer, and/or any other information associated with the content item 302 and/or one or more portions of the content item 302 (e.g., episodes, frames, segments, etc.).

The metadata 620 generated by the data processing system(s) 130 can be used for various purposes. For example, in some cases, the metadata 620 can be used to select advertisements to include with the content item 302, sell advertising slots to advertisers, create and/or implement advertising campaigns, enhance/enrich and/or tailor content experiences for users, etc. In some cases, the metadata 620 can be used to create certain content such as, for example, trailers, previews, shorts, thumbnails, etc.

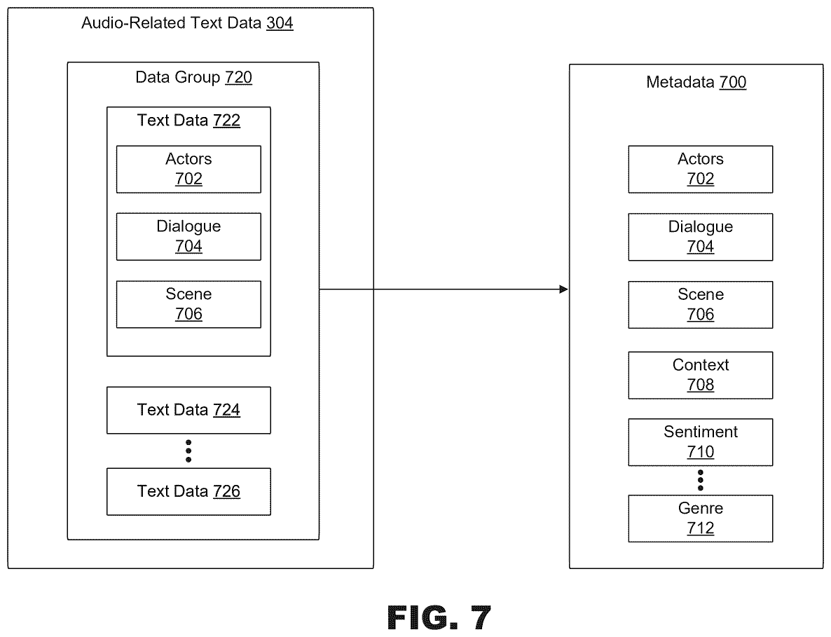

FIG. 7 is a diagram illustrating an example correlation between portions of the audio-related text data 304 and metadata 700 generated by the data processing system(s) 130 based on the audio-related text data 304, according to some examples of the present disclosure. In this example, the audio-related text data 304 includes a data group 720 that includes text data 722-726 grouped and/or stitched together. The text data 722-726 in the data group 720 can include data from the audio-related text data 304 and can optionally include other data added to the data group 720 in the audio-related text data 304 from one or more other sources, such as the image data 306 and/or the audio data 308.

In this example, the text data 722 in the data group 720 includes data about and/or corresponding to one or more actors 702 associated with the content item 302, a dialogue 704 in the content item 302 (e.g., a dialogue involving the one or more actors 702), and a scene 706 associated with the content item 302 (e.g., a scene depicted, identified, included, and/or described in the content item 302). The text data 724 and the text data 726 in the data group 720 can include other, relevant information such as, for example, context information, event information, content information, etc.

The data processing system(s) 130 can use the text data 722-726 in the data group 720 to generate the metadata 700. In this example, the metadata 700 includes information about the actors 702, the dialogue 704, and the scene 706. The data processing system(s) 130 can extract the information associated with the actors 702, the dialogue 704, and the scene 706 from the text data 722 in the data group 720, and include such information in the metadata 700.

The metadata 700 also includes information about a context 708 associated with the content item 302, such as a context associated with the actors 702, the dialogue 704, the scene 706, and/or associated content; a sentiment 710 associated with the content item 302, such as a sentiment (e.g., mood, tone, etc.) of the actors 702, a sentiment conveyed in the dialogue 704, a sentiment associated with the scene 706, and/or a sentiment extracted/recognized from associated content; and a genre 712 associated with the content item 302. In some examples, the data processing system(s) 130 can extract and/or generate the information pertaining to the context 708, the sentiment 710, and the genre 712 from the text data 722, the text data 724, and/or the text data 726.

The metadata examples shown in FIG. 7 are merely illustrative examples provided for explanation purposes. One of ordinary skill in the art will recognize that, in other examples, the metadata 700 can include other types of metadata (e.g., instead of or in addition to any of the metadata examples shown in FIG. 7) and/or a different amount of metadata.

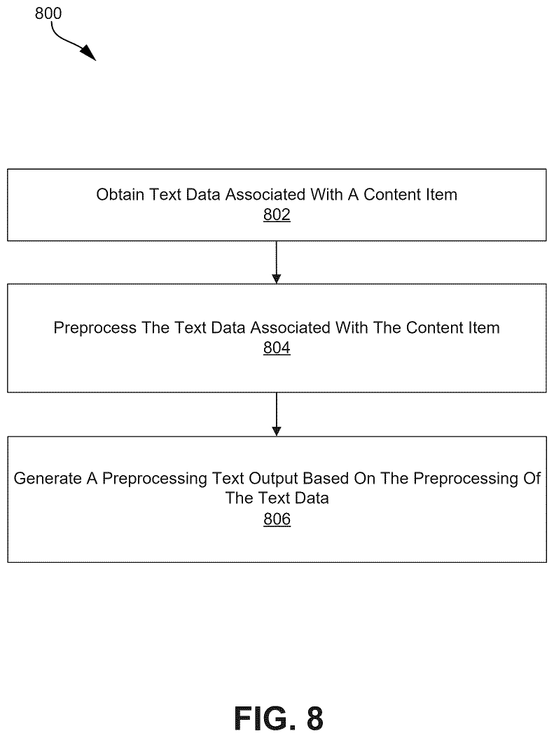

FIG. 8 is a flowchart illustrating an example method 800 for preprocessing text data associated with a content item to generate a preprocessed text output used to generate metadata for the content item, according to some examples of the present disclosure. The method 800 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 800. Further, some of the steps may be performed simultaneously, or in a different order than shown in FIG. 8, as will be understood by a person of ordinary skill in the art. The method 800 shall be described with reference to FIG. 1. However, the method 800 is not limited to that example.

Method 800 shall be described with reference to FIG. 3 and FIG. 6. However, method 800 is not limited to that example. At step 802, the data preprocessing system(s) 128 can obtain text data (e.g., audio-related text data 304) associated with a content item (e.g., content item 302). In some examples, the text data can include a transcription and/or a translation of audio (e.g., audio data 308) associated with the content item.

In some aspects, the text data can include closed captions and/or subtitles, and the content item can include a movie, a television show, a livestream, a podcast, a video game, a video conference, an audio, and/or a media broadcast including video and/or audio.

At step 804, the data preprocessing system(s) 128 can preprocess the text data associated with the content item. At step 806, the data preprocessing system(s) 128 can generate a preprocessing text output (e.g., preprocessed data output 310) based on the preprocessing of the text data. In some examples, the preprocessing text output can group portions of the text data based on topics.

In other examples, the preprocessing text output can additionally or alternatively group a portion of the text data associated with a deviation in a playback timeline of the content item with an additional portion of the text data selected based on one or more relationships between the portion of the text data and the additional portion of the text data. The one or more relationships can include, for example, a chronological relationship, a contextual relationship, and/or a common timeline associated with the portion of the text data and/or the additional portion of the text data.

In some cases, the preprocessing text output can arrange data in the modified version of the text data based on the sequence of events associated with the content item and/or the content of the content item. In some examples, arranging the data in the modified version of the text data based on the sequence can include ordering the data in the modified version of the text data according to a chronological timeline associated with the content item.

In some aspects, the preprocessing text output can include additional text data generated based on the audio associated with the content item and/or image data associated with the content item. The image data can include, for example, one or more video frames, graphics, and/or one or more still images.

In some aspects, the deviation in the playback timeline can include a flashback, a flashforward, and/or a content recap. In some cases, preprocessing the text data can include detecting the deviation in the playback timeline of the content item.

In some cases, detecting the deviation in the playback timeline of the content item can be based on a portion of the text data associated with the deviation in the playback timeline of the content item, the audio associated with the content item, and/or image data (e.g., video frames, still images, graphics, etc.) associated with the content item.

In some cases, detecting the deviation in the playback timeline of the content item can include based on the image data, recognizing, using facial recognition, a character depicted in a portion of the image data corresponding to the deviation in the playback timeline; and detecting the deviation in the playback timeline of the content item based on a determination that the character is associated with a first segment of the playback timeline that is chronologically before a second segment of the playback timeline corresponding to the deviation in the playback timeline.

In some cases, detecting the deviation in the playback timeline of the content item can include based on the image data, recognizing, using scene or image recognition, a scene depicted in a portion of the image data corresponding to the deviation in the playback timeline; and detecting the deviation in the playback timeline of the content item based on a determination that the scene matches a previous scene in the playback timeline or the scene is associated with a segment of the playback timeline that is before a second segment of the playback timeline corresponding to the deviation in the playback timeline.

In some cases, detecting the deviation in the playback timeline of the content item can include recognizing, using speech or voice recognition, an utterance in the audio associated with the content item, speech in the audio associated with the content item, an/or a voice in the audio associated with the content item; and detecting the deviation in the playback timeline of the content item based on a first determination that at least one of the voice and a character associated with the voice is associated with a first segment of the playback timeline that is before a second segment of the playback timeline corresponding to the deviation in the playback timeline; and/or a second determination that at least one of the utterance, the voice, and the speech is associated with the first segment of the playback timeline.

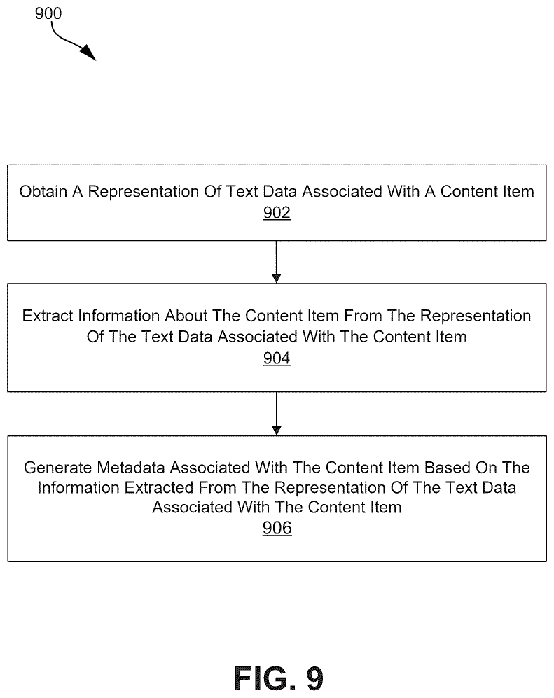

FIG. 9 is a flowchart illustrating an example method 900 for using models to generate context-aware metadata for a content item, according to some examples of the present disclosure. The method 900 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 900. Further, some of the steps may be performed simultaneously, or in a different order than shown in FIG. 9, as will be understood by a person of ordinary skill in the art. The method 900 shall be described with reference to FIG. 1. However, the method 900 is not limited to that example.

Method 900 shall be described with reference to FIG. 3 and FIG. 6. However, method 900 is not limited to that example. At step 902, the data processing system(s) 130 can obtain a representation of text data (e.g., the preprocessed data output 310 associated with the audio-related text data 304) associated with a content item (e.g., content item 302).

At step 904, the data processing system(s) 130 can extract information about the content item from the representation of the text data associated with the content item. In some cases, extracting information from the representation of the text data can include identifying information in the representation of the text data, inferring information about the content item from the representation of the text data, generating information based on the representation of the text data, and/or determining information about the content item based on the representation of the text data.

In some examples, the information extracted from the representation of the text data can include any information associated with the content item such as, for example and without limitation, an IAB category, a topic, a title, a description, a cast, a genre, a rating, a summary, etc.

At step 906, the data processing system(s) 130 can generate metadata associated with the content item based on the information extracted from the representation of the text data associated with the content item. In some aspects, the metadata can include any information associated with the content item such as, for example and without limitation, an IAB category, a topic, a title, a description, a cast, a genre, a rating, a summary, etc.

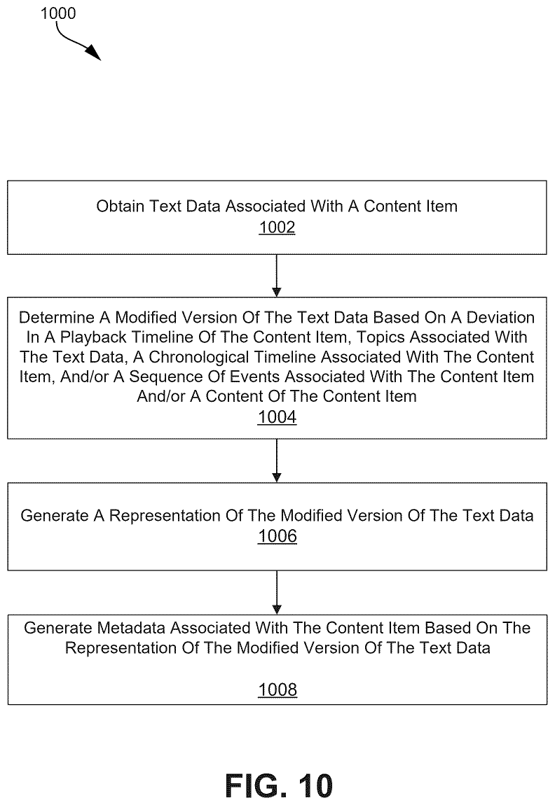

FIG. 10 is a flowchart illustrating an example method 1000 for using preprocessing text data associated with a content item to generate context-aware metadata for the content item. The method 1000 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 1000. Further, some of the steps may be performed simultaneously, or in a different order than shown in FIG. 10, as will be understood by a person of ordinary skill in the art. The method 1000 shall be described with reference to FIG. 1. However, the method 1000 is not limited to that example.

Method 1000 shall be described with reference to FIG. 3 and FIG. 6. However, method 1000 is not limited to that example. At step 1002, the data preprocessing system(s) 128 can obtain text data (e.g., audio-related text data 304) associated with a content item (e.g., content item 302). In some examples, the text data can include a transcription and/or a translation of audio (e.g., audio data 308) associated with the content item.

In some aspects, the text data can include closed captions and/or subtitles, and the content item can include a movie, a television show, a livestream, a podcast, a video game, a video conference, an audio, and/or a media broadcast including video and/or audio.

At step 1004, the data preprocessing system(s) 128 can determine a modified version of the text data based on a deviation in a playback timeline of the content item, topics associated with the text data, a chronological timeline associated with the content item, and/or a sequence of events associated with the content item and/or a content of the content item. For example, the data preprocessing system(s) 128 can receive as input the text data (and, optionally, other data such as the image data 306 and/or the audio data 308) and, based on the input, generate/output a modified version of the text data that modifies the text data (or portions thereof) based on a deviation in a playback timeline of the content item identified or recognized by the data preprocessing system(s) 128, topics associated with the text data (e.g., common topics identified or recognized in the text data), a chronological timeline associated with the content item (e.g., a chronological timeline of any content(s), story/stories, plot(s), events, information, video frames, episode(s), chapter(s), segment(s), and/or sequence(s) of, from, associated with, and/or conveyed by the content item), a sequence(s) of events associated with the content item, and/or a sequence(s) associated with any content(s) of the content item.

In some examples, the modified version of the text data can group portions of the text data based on topics. In other examples, the modified version of the text data can additionally or alternatively group a portion of the text data associated with the deviation in the playback timeline with an additional portion of the text data selected based on one or more relationships between the portion of the text data and the additional portion of the text data. In some cases, the one or more relationships can include a chronological relationship, a contextual relationship, and/or a common timeline (e.g., a same, similar, matching, or shared timeline) associated with the portion of the text data and the additional portion of the text data.

In some aspects, the modified version of the text data can arrange data in the modified version of the text data based on the sequence of events associated with the content item and/or the content of the content item. In some examples, arranging the data in the modified version of the text data based on the sequence can include ordering the data in the modified version of the text data according to a chronological timeline associated with the content item.

In some examples, the modified version of the text data can include additional text data generated based on the audio associated with the content item and/or image data (e.g., image data 306) associated with the content item. In some cases, the image data can include one or more video frames, one or more graphics, and/or one or more still images.

At step 1006, the data preprocessing system(s) 128 can generate a representation of the modified version of the text data (e.g., preprocessed data output 310). In some cases, the representation of the modified version of the text data can include text embeddings generated based on the modified version of the text data. In some cases, the representation of the modified version of the text data can include the text data configured according to the modified version of the text data. In some aspects, the representation of the modified version of the text data can optionally include additional data, such as additional text data generated based on the audio associated with the content item and/or image data (e.g., image data 306) associated with the content item.

At step 1008, the data processing system(s) 130 can generate metadata (e.g., metadata 620) associated with the content item based on the representation of the modified version of the text data. The metadata can include any information associated with the content item such as, for example and without limitation, an IAB category, a topic, a title, a description, a cast, a genre, a rating, a summary, etc.

In some aspects, the data preprocessing system(s) 128 can detect the deviation in the playback timeline of the content item based on a portion of the text data associated with the deviation in the playback timeline of the content item, the audio associated with the content item, and/or image data (e.g., video frames, still images, etc.) associated with the content item. In some examples, the deviation in the playback timeline can include a flashback, a flashforward, and/or a content recap.

In some aspects, detecting the deviation in the playback timeline of the content item can include based on the image data, recognizing, using facial recognition, a character depicted in a portion of the image data corresponding to the deviation in the playback timeline; and detecting the deviation in the playback timeline of the content item based on a determination that the character is associated with a first segment of the playback timeline that is chronologically before a second segment of the playback timeline corresponding to the deviation in the playback timeline.

In some aspects, detecting the deviation in the playback timeline of the content item can include based on the image data, recognizing using scene or image recognition, a scene depicted in a portion of the image data corresponding to the deviation in the playback timeline; and detecting the deviation in the playback timeline of the content item based on a determination that the scene matches a previous scene in the playback timeline or the scene is associated with a segment of the playback timeline that is before a second segment of the playback timeline corresponding to the deviation in the playback timeline.

In some aspects, detecting the deviation in the playback timeline of the content item can include recognizing, using speech or voice recognition, an utterance in the audio associated with the content item, speech in the audio associated with the content item, and/or a voice in the audio associated with the content item; and detecting the deviation in the playback timeline of the content item based on a first determination that the voice and/or a character associated with the voice is associated with a first segment of the playback timeline that is before a second segment of the playback timeline corresponding to the deviation in the playback timeline; and/or a second determination that the utterance, the voice, and/or the speech is associated with the first segment of the playback timeline.

### Example Neural Network Architectures

FIG. 11 is a diagram illustrating an example architecture 1100 of an example neural network 1110. The example architecture 1100 can be used to implement some or all of the neural networks described herein. The architecture 1100 of the neural network 1110 can include an input layer 1120 that can be configured to receive and process data to generate one or more outputs. The architecture 1100 of the neural network 1110 can also include hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The architecture 1100 of the neural network 1110 can further include an output layer 1121 that provides an output resulting from the processing performed by the hidden layers 1122a, 1122b, through 1122n.

The neural network 1110 is a multi-layer neural network of interconnected nodes. Each node can represent a piece of information. Information associated with the nodes is shared among the different layers and each layer retains information as information is processed. In some cases, the neural network 1110 can include a feed-forward network, in which case there are no feedback connections where outputs of the network are fed back into itself. In some cases, the neural network 1110 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the first hidden layer 1122a can transform the information of each input node by applying activation functions to the input node information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1121, at which an output is provided. In some cases, while nodes in the neural network 1110 are shown as having multiple output lines, a node can have a single output and all lines shown as being output from a node represent the same output value.

In some cases, each node or interconnection between nodes can have a weight that is a set of parameters derived from the training of the neural network 1110. Once the neural network 1110 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network 1110 to be adaptive to inputs and able to learn as more and more data is processed.

The neural network 1110 is pre-trained to process the features from the data in the input layer 1120 using the different hidden layers 1122a, 1122b, through 1122n in order to provide the output through the output layer 1121.

In some cases, the neural network 1110 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 1110 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 1110 can perform a backward pass by determining which inputs (weights) most contributed to the loss of the network and can adjust the weights so that the loss decreases and is eventually minimized.

The neural network 1110 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 1110 can include any other deep network other than a CNN, such as a transformer, an encoder-decoder network, an encoder-only network, a decoder-only network, a mixture of experts (MoE) network, a generative model network, an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

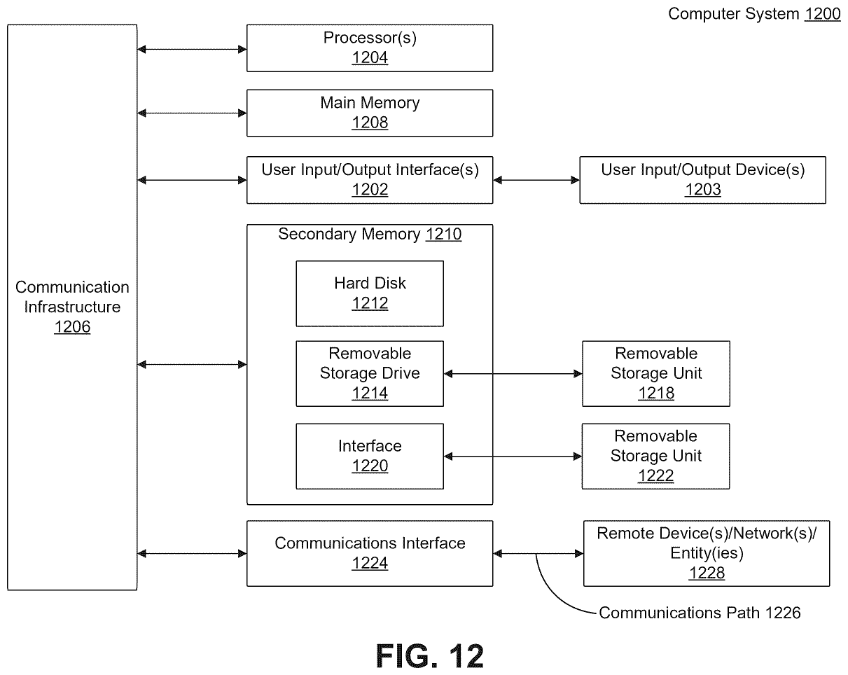

Various aspects and examples may be implemented, for example, using one or more well-known computer systems, such as computer system 1200 shown in FIG. 12. For example, the one or more media devices 106, the one or more content servers 120, the one or more system servers 126 (e.g., including the data preprocessing system(s) 128, the data processing system(s) 130, the audio command processing system(s) 132, and/or any device or devices implementing the data preprocessing system(s) 128, the data processing system(s) 130, and/or the audio command processing system(s) 132) may be implemented using combinations or sub-combinations of computer system 1200. Also or alternatively, computer system 1200 may be used, for example, to implement any of the aspects and examples discussed herein, as well as combinations and sub-combinations thereof.

Computer system 1200 may include one or more processors (e.g., central processing units or CPUs), such as processor 1204. Processor 1204 may be connected to a communication infrastructure 1206 (or communication bus).

Computer system 1200 may also include user input/output device(s) 1203, such as monitors, keyboards, pointing devices, etc., which may communicate with communication infrastructure 1206 through user input/output interface(s) 1202.

In some examples, the one or more processors 1204 may include a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. In other examples, the one or more processors 1204 may additionally or alternatively include or be part of a digital signal processor (DSP), an image signal processor (ISP), an application-specific integrated circuit (ASIC), a field-programmable gate array (FPGA), an integrated circuit, a microcontroller, and/or any other processing device.

Computer system 1200 may also include a main or primary memory 1208, such as random access memory (RAM). Main memory 1208 may include one or more levels of cache. Main memory 1208 may have stored therein control logic (e.g., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 may include a computer usable or readable storage device having stored thereon computer software (control logic) and/or data. Removable storage unit 1218 may be a floppy disk, magnetic tape, compact disk, DVD, optical storage disk, and/any other computer data storage device. Removable storage drive 1214 may read from and/or write to removable storage unit 1218.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1200 may include a communication or network interface 1224. Communication interface 1224 may enable computer system 1200 to communicate and interact with any combination of external devices, external networks, external entities, etc. (individually and collectively referenced by reference number 1228). For example, communication interface 1224 may allow computer system xx00 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200 or processor(s) 1204), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising memory and one or more processors coupled to the memory and configured to perform operations comprising: obtaining text data associated with a content item, the text data comprising at least one of a transcription and a translation of audio associated with the content item; determining a modified version of the text data based on at least one of a deviation in a playback timeline of the content item, topics associated with the text data, a chronological timeline associated with the content item, and a sequence of at least one of events associated with the content item and a content of the content item; generating a representation of the modified version of the text data; and generating metadata associated with the content item based on the representation of the modified version of the text data.

Aspect 2. The system of Aspect 1, wherein portions of text data in the modified version of the text data are grouped based on topics.

Aspect 3. The system of any of Aspects 1 to 2, wherein the modified version of the text data arranges data in the modified version of the text data based on the sequence of at least one of events associated with the content item and the content of the content item.

Aspect 4. The system of Aspect 3, wherein arranging the data in the modified version of the text data based on the sequence comprises ordering the data in the modified version of the text data according to a chronological timeline associated with the content item.

Aspect 5. The system of any of Aspects 1 to 4, wherein the modified version of the text data groups a portion of the text data associated with the deviation in the playback timeline with an additional portion of the text data selected based on one or more relationships between the portion of the text data and the additional portion of the text data, wherein the one or more relationships comprise at least one of a chronological relationship, a contextual relationship, and a common timeline associated with the portion of the text data and the additional portion of the text data.

Aspect 6. The system of any of Aspects 1 to 5, wherein the modified version of the text data comprises additional text data generated based on at least one of the audio associated with the content item and image data associated with the content item, the image data comprising at least one of one or more video frames and one or more still images.

Aspect 7. The system of any of Aspects 1 to 6, wherein the operations further comprise: detecting the deviation in the playback timeline of the content item based on at least one of a portion of the text data associated with the deviation in the playback timeline of the content item, the audio associated with the content item, and image data associated with the content item, the image data comprising at least one of one or more video frames and one or more still images.

Aspect 8. The system of Aspect 7, wherein the deviation in the playback timeline comprises at least one of a flashback, a flashforward, and a content recap, and wherein the text data comprises at least one of closed captions and subtitles, and wherein the content item comprises at least one of a movie, a television show, a livestream, a podcast, a video game, a video conference, an audio, and a media broadcast comprising at least one of video and audio.

Aspect 9. The system of any of Aspects 7 to 8, wherein detecting the deviation in the playback timeline of the content item comprises: based on the image data, recognizing, using facial recognition, a character depicted in a portion of the image data corresponding to the deviation in the playback timeline; and detecting the deviation in the playback timeline of the content item based on a determination that the character is associated with a first segment of the playback timeline that is chronologically before a second segment of the playback timeline corresponding to the deviation in the playback timeline.

Aspect 10. The system of any of Aspects 7 to 9, wherein detecting the deviation in the playback timeline of the content item comprises: based on the image data, recognizing, using scene or image recognition, a scene depicted in a portion of the image data corresponding to the deviation in the playback timeline; and detecting the deviation in the playback timeline of the content item based on a determination that the scene matches a previous scene in the playback timeline or the scene is associated with a segment of the playback timeline that is before a second segment of the playback timeline corresponding to the deviation in the playback timeline.

Aspect 11. The system of any of Aspects 7 to 10, wherein detecting the deviation in the playback timeline of the content item comprises: recognizing, using speech or voice recognition, at least one of an utterance in the audio associated with the content item, speech in the audio associated with the content item, and a voice in the audio associated with the content item; and detecting the deviation in the playback timeline of the content item based on at least one of: a first determination that at least one of the voice and a character associated with the voice is associated with a first segment of the playback timeline that is before a second segment of the playback timeline corresponding to the deviation in the playback timeline; and a second determination that at least one of the utterance, the voice, and the speech is associated with the first segment of the playback timeline.

Aspect 12. A computer-implemented method comprising: obtaining text data associated with a content item, the text data comprising at least one of a transcription and a translation of audio associated with the content item; determining a modified version of the text data based on at least one of a deviation in a playback timeline of the content item, topics associated with the text data, a chronological timeline associated with the content item, and a sequence of at least one of events associated with the content item and a content of the content item; generating a representation of the modified version of the text data; and generating metadata associated with the content item based on the representation of the modified version of the text data.

Aspect 13. The computer-implemented method of Aspect 12, wherein portions of text data in the modified version of the text data are grouped based on topics.

Aspect 14. The computer-implemented method of any of Aspects 12 or 13, wherein the modified version of the text data arranges data in the modified version of the text data based on the sequence of at least one of events associated with the content item and the content of the content item.

Aspect 15. The computer-implemented method of Aspect 14, wherein arranging the data in the modified version of the text data based on the sequence comprises ordering the data in the modified version of the text data according to a chronological timeline associated with the content item.

Aspect 16. The computer-implemented method of any of Aspects 12 to 15, wherein the modified version of the text data groups a portion of the text data associated with the deviation in the playback timeline with an additional portion of the text data selected based on one or more relationships between the portion of the text data and the additional portion of the text data, wherein the one or more relationships comprise at least one of a chronological relationship, a contextual relationship, and a common timeline associated with the portion of the text data and the additional portion of the text data.

Aspect 17. The computer-implemented method of any of Aspects 12 to 16, wherein the modified version of the text data comprises additional text data generated based on at least one of the audio associated with the content item and image data associated with the content item, the image data comprising at least one of one or more video frames and one or more still images.

Aspect 18. The computer-implemented method of any of Aspects 12 to 17, wherein the operations further comprise: detecting the deviation in the playback timeline of the content item based on at least one of a portion of the text data associated with the deviation in the playback timeline of the content item, the audio associated with the content item, and image data associated with the content item, the image data comprising at least one of one or more video frames and one or more still images.

Aspect 19. The computer-implemented method of Aspect 18, wherein the deviation in the playback timeline comprises at least one of a flashback, a flashforward, and a content recap, and wherein the text data comprises at least one of closed captions and subtitles, and wherein the content item comprises at least one of a movie, a television show, a livestream, a podcast, a video game, a video conference, an audio, and a media broadcast comprising at least one of video and audio.

Aspect 20. The computer-implemented method of any of Aspects 18 or 19, wherein detecting the deviation in the playback timeline of the content item comprises: based on the image data, recognizing, using facial recognition, a character depicted in a portion of the image data corresponding to the deviation in the playback timeline; and detecting the deviation in the playback timeline of the content item based on a determination that the character is associated with a first segment of the playback timeline that is chronologically before a second segment of the playback timeline corresponding to the deviation in the playback timeline.

Aspect 21. The computer-implemented method of any of Aspects 18 to 20, wherein detecting the deviation in the playback timeline of the content item comprises: based on the image data, recognizing, using scene or image recognition, a scene depicted in a portion of the image data corresponding to the deviation in the playback timeline; and detecting the deviation in the playback timeline of the content item based on a determination that the scene matches a previous scene in the playback timeline or the scene is associated with a segment of the playback timeline that is before a second segment of the playback timeline corresponding to the deviation in the playback timeline.

Aspect 21. The computer-implemented method of any of Aspects 18 to 20, wherein detecting the deviation in the playback timeline of the content item comprises: recognizing, using speech or voice recognition, at least one of an utterance in the audio associated with the content item, speech in the audio associated with the content item, and a voice in the audio associated with the content item; and detecting the deviation in the playback timeline of the content item based on at least one of: a first determination that at least one of the voice and a character associated with the voice is associated with a first segment of the playback timeline that is before a second segment of the playback timeline corresponding to the deviation in the playback timeline; and a second determination that at least one of the utterance, the voice, and the speech is associated with the first segment of the playback timeline.

Aspect 22. A non-transitory computer-readable medium having instructions stored thereon that, when executed by one or more processors, cause the one or more processors to perform a method according to any of Aspects 12 to 21.

Aspect 23. A system comprising means for performing a method according to any of Aspects 12 to 21.

What is claimed is:

1. A system comprising:
memory; and
one or more processors coupled to the memory and configured to perform operations comprising:
obtaining text data associated with a content item, the text data comprising at least one of a transcription and a translation of audio associated with the content item;
determining a modified version of the text data based on at least one of a deviation in a playback timeline of the content item, topics associated with the text data, a chronological timeline associated with the content item, and a sequence of at least one of events associated with the content item and a content of the content item;
generating a representation of the modified version of the text data; and
generating metadata associated with the content item based on the representation of the modified version of the text data.

2. The system of claim 1, wherein portions of text data in the modified version of the text data are grouped based on topics.

3. The system of claim 1, wherein the modified version of the text data arranges data in the modified version of the text data based on the sequence of at least one of events associated with the content item and the content of the content item.

4. The system of claim 3, wherein arranging the data in the modified version of the text data based on the sequence comprises ordering the data in the modified version of the text data according to a chronological timeline associated with the content item.

5. The system of claim 1, wherein the modified version of the text data groups a portion of the text data associated with the deviation in the playback timeline with an additional portion of the text data selected based on one or more relationships between the portion of the text data and the additional portion of the text data, wherein the one or more relationships comprise at least one of a chronological relationship, a contextual relationship, and a common timeline associated with the portion of the text data and the additional portion of the text data.

6. The system of claim 1, wherein the modified version of the text data comprises additional text data generated based on at least one of the audio associated with the content item and image data associated with the content item, the image data comprising at least one of one or more video frames and one or more still images.

7. The system of claim 1, wherein the operations further comprise:
detecting the deviation in the playback timeline of the content item based on at least one of a portion of the text data associated with the deviation in the playback timeline of the content item, the audio associated with the content item, and image data associated with the content item, the image data comprising at least one of one or more video frames and one or more still images.

8. The system of claim 7, wherein the deviation in the playback timeline comprises at least one of a flashback, a flashforward, and a content recap, and wherein the text data comprises at least one of closed captions and subtitles, and wherein the content item comprises at least one of a movie, a television show, a livestream, a podcast, a video game, a video conference, an audio, and a media broadcast comprising at least one of video and audio.

9. The system of claim 7, wherein detecting the deviation in the playback timeline of the content item comprises:
based on the image data, recognizing, using facial recognition, a character depicted in a portion of the image data corresponding to the deviation in the playback timeline; and
detecting the deviation in the playback timeline of the content item based on a determination that the character is associated with a first segment of the playback timeline that is chronologically before a second segment of the playback timeline corresponding to the deviation in the playback timeline.

10. The system of claim 7, wherein detecting the deviation in the playback timeline of the content item comprises:
based on the image data, recognizing, using scene or image recognition, a scene depicted in a portion of the image data corresponding to the deviation in the playback timeline; and
detecting the deviation in the playback timeline of the content item based on a determination that the scene matches a previous scene in the playback timeline or the scene is associated with a segment of the playback timeline that is before a second segment of the playback timeline corresponding to the deviation in the playback timeline.

11. The system of claim 7, wherein detecting the deviation in the playback timeline of the content item comprises:
recognizing, using speech or voice recognition, at least one of an utterance in the audio associated with the content item, speech in the audio associated with the content item, and a voice in the audio associated with the content item; and
detecting the deviation in the playback timeline of the content item based on at least one of:
a first determination that at least one of the voice and a character associated with the voice is associated with a first segment of the playback timeline that is before a second segment of the playback timeline corresponding to the deviation in the playback timeline; and
a second determination that at least one of the utterance, the voice, and the speech is associated with the first segment of the playback timeline.

12. A computer-implemented method comprising:
obtaining text data associated with a content item, the text data comprising at least one of a transcription and a translation of audio associated with the content item;
determining a modified version of the text data based on at least one of a deviation in a playback timeline of the content item, topics associated with the text data, a chronological timeline associated with the content item, and a sequence of at least one of events associated with the content item and a content of the content item;
generating a representation of the modified version of the text data; and
generating metadata associated with the content item based on the representation of the modified version of the text data.

13. The computer-implemented method of claim 12, wherein the modified version of the text data groups one or more portions of the modified version of the text data that are associated with the deviation in the playback timeline with one or more additional portions of modified version of the text data that are selected based on one or more relationships between the one or more portions of the modified version of the text data and the one or more additional portions of the modified version of the text data, wherein the one or more relationships comprise at least one of a topic, a chronological relationship, a contextual relationship, and a common timeline.

14. The computer-implemented method of claim 12, wherein the modified version of the text data arranges data in the modified version of the text data based on the sequence of at least one of events associated with the content item and the content of the content item, wherein arranging the data in the modified version of the text data based on the sequence comprises ordering the data in the modified version of the text data according to a chronological timeline associated with the content item.

15. The computer-implemented method of claim 12, wherein the modified version of the text data comprises additional text data generated based on at least one of the audio associated with the content item and image data associated with the content item, the image data comprising at least one of one or more video frames and one or more still images.

16. The computer-implemented method of claim 12, further comprising:
detecting the deviation in the playback timeline of the content item based on at least one of a portion of the text data associated with the deviation in the playback timeline of the content item, the audio associated with the content item, and image data associated with the content item, the image data comprising at least one of one or more video frames and one or more still images, wherein the deviation in the playback timeline comprises at least one of a flashback, a flashforward, and a content recap, and wherein the text data comprises at least one of closed captions and subtitles, and wherein the content item comprises at least one of a movie, a television show, a livestream, a podcast, a video game, a video conference, an audio, and a media broadcast comprising at least one of video and audio.

17. The computer-implemented method of claim 16, wherein detecting the deviation in the playback timeline of the content item comprises:
based on the image data, recognizing, using facial recognition, a character depicted in a portion of the image data corresponding to the deviation in the playback timeline; and
detecting the deviation in the playback timeline of the content item based on a determination that the character is associated with a first segment of the playback timeline that is chronologically before a second segment of the playback timeline corresponding to the deviation in the playback timeline.

18. The computer-implemented method of claim 16, wherein detecting the deviation in the playback timeline of the content item comprises:
based on the image data, recognizing, using scene or image recognition, a scene depicted in a portion of the image data corresponding to the deviation in the playback timeline; and
detecting the deviation in the playback timeline of the content item based on a determination that the scene matches a previous scene in the playback timeline or the scene is associated with a segment of the playback timeline that is before a second segment of the playback timeline corresponding to the deviation in the playback timeline.

19. The computer-implemented method of claim 16, wherein detecting the deviation in the playback timeline of the content item comprises:
recognizing, using speech or voice recognition, at least one of an utterance in the audio associated with the content item, speech in the audio associated with the content item, and a voice in the audio associated with the content item; and
detecting the deviation in the playback timeline of the content item based on at least one of:
a first determination that at least one of the voice and a character associated with the voice is associated with a first segment of the playback timeline that is before a second segment of the playback timeline corresponding to the deviation in the playback timeline; and
a second determination that at least one of the utterance, the voice, and the speech is associated with the first segment of the playback timeline.

20. A non-transitory computer-readable medium having instructions stored thereon that, when executed by one or more processors, cause the one or more processors to perform operations comprising:
obtaining text data associated with a content item, the text data comprising at least one of a transcription and a translation of audio associated with the content item;
determining a modified version of the text data based on at least one of a deviation in a playback timeline of the content item, topics associated with the text data, a chronological timeline associated with the content item, and a sequence of at least one of events associated with the content item and a content of the content item;
generating a representation of the modified version of the text data; and
generating metadata associated with the content item based on the representation of the modified version of the text data.
